(19) United States
(12) Patent Application Publication
(10) Pub. No.: US 2023/0186142 A1
(43) Pub. Date: Jun. 15, 2023

(54) TECHNOLOGIES FOR HIGH-SPEED INTERFACES FOR CRYOGENIC QUANTUM CONTROL

(71) Applicant: Intel Corporation, Santa Clara, CA (US)

(72) Inventors: Todor Mladenov, Portland, OR (US); JongSeok Park, Hillsboro, OR (US); Stefano Pellerano, Beaverton, OR (US); Sushil Subramanian, Beaverton, OR (US)

(73) Assignee: Intel Corporation, Santa Clara, CA (US)

(21) Appl. No.: 17/549,154

(22) Filed: Dec. 13, 2021

(51) Int. Cl. G06N 10/80; G06N 10/60

(52) U.S. Cl. CPC G06N 10/80; G06N 10/60; G06N 10/40

(57) ABSTRACT

Technologies for high-speed interfaces for cryogenic quantum control are disclosed. In the illustrative embodiment, a die for quantum/classical interface circuitry includes digital circuitry operating in a first clock domain and analog circuitry operating in a second clock domain. Clock domain crossing circuitry facilitates asynchronous data transfer from the digital circuitry to the analog circuitry. The illustrative clock domain crossing circuitry includes a first asynchronous first-in-first-out (FIFO) queue at the border of the first clock domain. The first asynchronous FIFO queue is connected to a second asynchronous FIFO queue at the border of the second clock domain.

### BACKGROUND

Quantum computers promise computational abilities not feasible with classical computing. One of many challenges in quantum computing is interfacing with a large number of qubits. Digital and analog circuitry are both used, and a reliable, high-speed interface between the digital and analog circuitry is desired. If the digital and analog circuitry are placed relatively far from each other on a die or are placed on different dies, such an interface can be difficult due to issues such as the circuitry possibly running on different clocks.

### BRIEF DESCRIPTION OF THE DRAWINGS

FIGS. 1A-1F illustrate various views of an example quantum compute device, in accordance with one embodiment.

FIG. 2 is a simplified block diagram of at least one embodiment of a quantum compute device.

FIG. 3 illustrates an example embodiment of circuitry of the quantum compute device of FIG. 2, including digital circuitry, analog circuitry, and clock domain crossing circuitry.

FIG. 4 illustrates an example embodiment of part of the digital circuitry and clock domain crossing circuitry of FIG. 3.

FIG. 5 is a simplified flow diagram of at least one embodiment of a method for designing the circuitry of FIG. 3.

FIG. 6 is a top view of a wafer and dies, in accordance with any of the embodiments disclosed herein.

FIG. 7 is a cross-sectional side view of an integrated circuit, in accordance with any of the embodiments disclosed herein.

FIGS. 8A-8D are perspective views of example planar, gate-all-around, and stacked gate-all-around transistors.

FIG. 9 is a cross-sectional side view of an integrated circuit device assembly, in accordance with any of the embodiments disclosed herein.

FIG. 10 is a block diagram of an example electrical device, in accordance with any of the embodiments disclosed herein.

### DETAILED DESCRIPTION

Aspects of the present disclosure may include a quantum compute device with quantum/classical interface circuitry that includes digital circuitry, analog circuitry, and clock domain crossing circuitry to provide an interface between the digital circuitry and the analog circuitry. In the illustrative embodiment, the analog circuitry interfaces with a quantum processor that includes one or more spin qubits, and the digital circuitry interfaces with other classical components of the quantum compute device. In the illustrative embodiment, the digital circuitry may be designed, placed, and routed independently from the analog circuitry. Aspects such as routing lines of the digital circuitry may be performed automatically using industry-standard tools, while aspects such as routing lines of the analog circuitry may be performed manually. Such an approach may lead to a signal processing data path discontinuity and presents challenges in efficient high-speed data transfers, particularly if the digital and analog circuitry are placed at a distance from each other on the same die or on different dies.

The illustrative clock domain crossing circuitry includes two asynchronous first-in-first-out (FIFO) queues, as discussed in more detail below. One FIFO queue is between a clock domain for the digital circuitry and a clock domain for the clock domain crossing circuitry, and one FIFO queue is between the clock for the clock domain crossing circuitry and a clock domain for the analog circuitry. The asynchronous nature of the FIFO queues allows for data to be transferred across clock domains. As an asynchronous FIFO queue is present at an interface with the digital clock domain and at an interface with the analog clock domain, each of the digital, analog, and clock domain-crossing circuitry can operate in a separate clock domain.

In the following description, specific details are set forth, but embodiments of the technologies described herein may be practiced without these specific details. Well-known circuits, structures, and techniques have not been shown in detail to avoid obscuring an understanding of this description. Phrases such as “an embodiment,” “various embodiments,” “some embodiments,” and the like may include features, structures, or characteristics, but not every embodiment necessarily includes the particular features, structures, or characteristics.

In the following description, for purposes of explanation, numerous specific details are set forth in order to provide a thorough understanding thereof. It may be evident, however, that the novel embodiments can be practiced without these specific details. In other instances, well-known structures and devices are shown in block diagram form in order to facilitate a description thereof. The intention is to cover all modifications, equivalents, and alternatives within the scope of the claims.

Some embodiments may have some, all, or none of the features described for other embodiments. “First,” “second,” “third,” and the like describe a common object and indicate different instances of like objects being referred to. Such adjectives do not imply objects so described must be in a given sequence, either temporally or spatially, in ranking, or any other manner. “Connected” may indicate elements are in direct physical or electrical contact, and “coupled” may indicate elements co-operate or interact, but they may or may not be in direct physical or electrical contact. Furthermore, the terms “comprising,” “including,” “having,” and the like, as used with respect to embodiments of the present disclosure, are synonymous. Terms modified by the word “substantially” include arrangements, orientations, spacings, or positions that vary slightly from the meaning of the unmodified term. For example, a substrate assembly feature, such as a through width, that is described as having substantially a listed dimension can vary within a few percent of the listed dimension.

As used herein, the phrase “communicatively coupled” refers to the ability of a component to send a signal to or receive a signal from another component. The signal can be any type of signal, such as an input signal, an output signal, or a power signal. A component can send or receive a signal to another component to which it is communicatively coupled via a wired or wireless communication medium (e.g., conductive traces, conductive contacts, air). Examples of components that are communicatively coupled include integrated circuit dies located in the same package that communicate via an embedded bridge in a package substrate and an integrated circuit component attached to a printed circuit board that send signals to or receives signals from other integrated circuit components or electronic devices attached to the printed circuit board.

It will be understood that in the examples shown and described further below, the figures may not be drawn to scale and may not include all possible layers and/or circuit components. In addition, it will be understood that although certain figures illustrate transistor designs with source/drain regions, electrodes, etc. having orthogonal (e.g., perpendicular) boundaries, embodiments herein may implement such boundaries in a substantially orthogonal manner (e.g., within +/−5 or 10 degrees of orthogonality) due to fabrication methods used to create such devices or for other reasons.

As used herein, the phrase “located on” in the context of a first layer or component located on a second layer or component refers to the first layer or component being directly physically attached to the second part or component (no layers or components between the first and second layers or components) or physically attached to the second layer or component with one or more intervening layers or components.

As used herein, the term “adjacent” refers to layers or components that are in physical contact with each other. That is, there is no layer or component between the stated adjacent layers or components. For example, a layer X that is adjacent to a layer Y refers to a layer that is in physical contact with layer Y.

As used herein, the terms “upper”/“lower” or “above”/“below” may refer to relative locations of an object (e.g., the surfaces described above), especially in light of examples shown in the attached figures, rather than an absolute location of an object. For example, an upper surface of an apparatus may be on an opposite side of the apparatus from a lower surface of the object, and the upper surface may be facing upward generally only when viewed in a particular way. As another example, a first object above a second object may be on or near an “upper” surface of the second object rather than near a “lower” surface of the object, and the first object may be truly above the second object only when the two objects are viewed in a particular way.

The disclosed embodiments may be implemented, in some cases, in hardware, firmware, software, or any combination thereof. The disclosed embodiments may also be implemented as instructions carried by or stored on a transitory or non-transitory machine-readable (e.g., computer-readable) storage medium, which may be read and executed by one or more processors. A machine-readable storage medium may be embodied as any storage device, mechanism, or other physical structure for storing or transmitting information in a form readable by a machine (e.g., a volatile or non-volatile memory, a media disc, or other media device).

References are made to the drawings, which are not necessarily drawn to scale, wherein similar or same numbers may be used to designate the same or similar parts in different figures. The use of similar or same numbers in different figures does not mean all figures including similar or same numbers constitute a single or same embodiment. Like numerals having different letter suffixes may represent different instances of similar components. The drawings illustrate generally, by way of example, but not by way of limitation, various embodiments discussed in the present document.

A quantum computer uses quantum-mechanical phenomena such as superposition and entanglement to perform computations, simulations, or other functions. In contrast to digital computers, which store data in one of two definite states (0 or 1), quantum computation uses quantum bits (qubits), which can be in superpositions of states. Qubits may be implemented using physically distinguishable quantum states of elementary particles such as electrons and photons. For example, the polarization of a photon may be used where the two states are vertical polarization and horizontal polarization. Similarly, the spin of an electron may have distinguishable states such as “up spin” and “down spin.” Qubits in quantum mechanical systems can be in a superposition of both states at the same time, a trait that is unique and fundamental to quantum computing.

Quantum computing systems execute algorithms containing quantum logic operations performed on qubits. In some cases, the result of the algorithm is not deterministic. The quantum algorithm may be repeated many times in order to determine a statistical distribution of results or in order to have a high likelihood of finding the correct answer. In some cases, a classical algorithm may be used to check if the quantum computer determined the correct result.

Qubits have been implemented using a variety of different technologies which are capable of manipulating and reading quantum states. These include but are not limited to quantum dot devices (spin-based and spatial-based), trapped-ion devices, superconducting quantum computers, optical lattices, nuclear magnetic resonance computers, solid-state NMR Kane quantum devices, electrons-on-helium quantum computers, cavity quantum electrodynamics (CQED) devices, molecular magnet computers, and fullerene-based ESR quantum computers, to name a few. Thus, while a quantum dot device is described below in relation to certain embodiments of the invention, the underlying principles of the invention may be employed in combination with any type of quantum computer, including, but not limited to, those listed above. The particular physical implementation used for qubits is not necessarily required for the embodiments of the invention described herein.

Quantum dots are small semiconductor particles, typically a few nanometers in size. Because of this small size, quantum dots operate according to the rules of quantum mechanics, having optical and electronic properties which differ from macroscopic entities. Quantum dots are sometimes referred to as “artificial atoms” to connote the fact that a quantum dot is a single object with discrete, bound electronic states, as is the case with atoms or molecules.

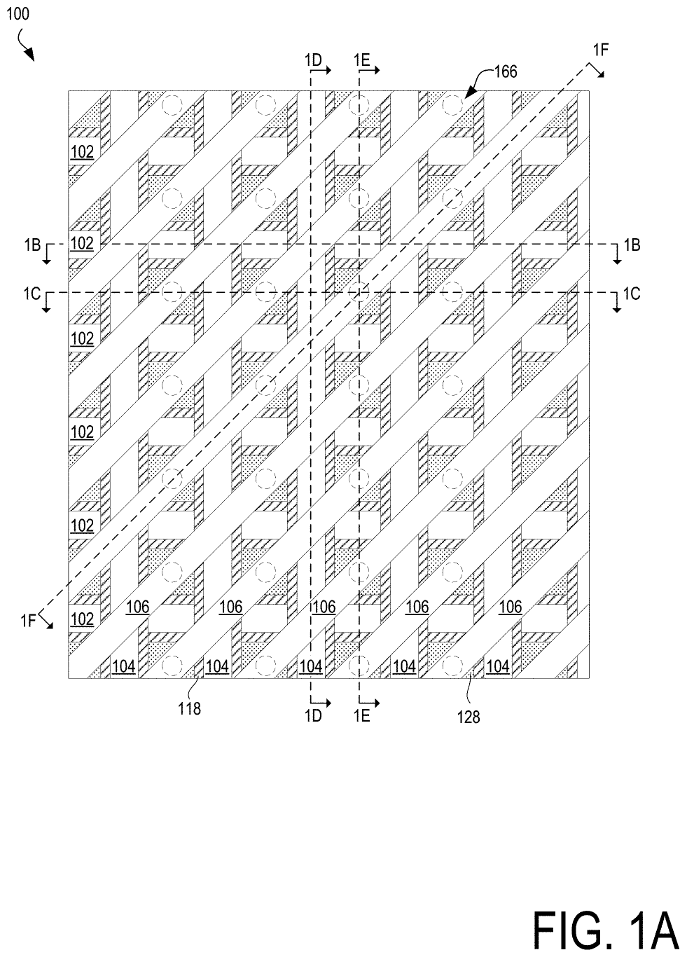

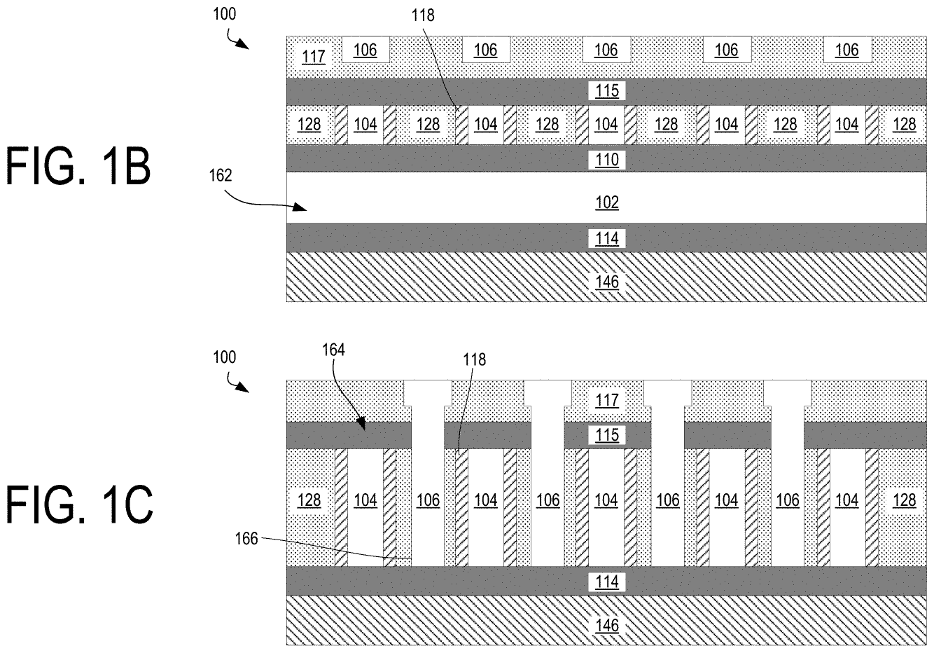

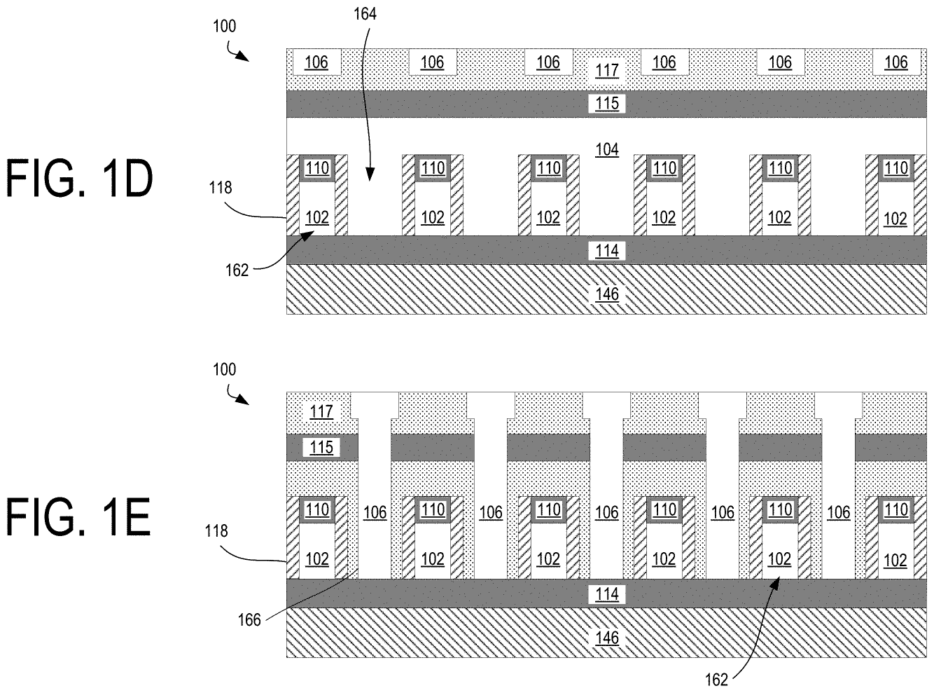

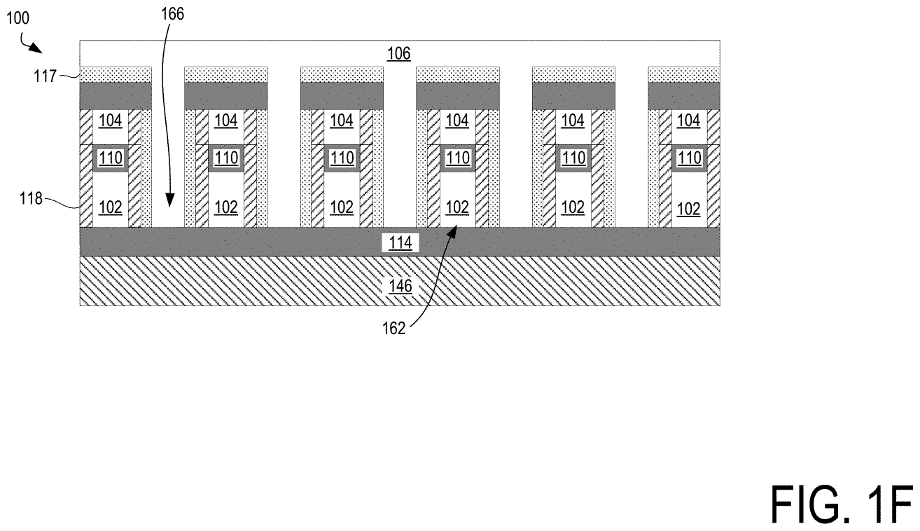

FIGS. 1A-1F are various views of a quantum dot device 100, which may be used with embodiments of the invention described below. FIG. 1A is a top view of a portion of the quantum dot device 100 with some of the materials removed so that the first gate lines 102, the second gate lines 104, and the third gate lines 106 are visible. Although many of the drawings and description herein may refer to a particular set of lines or gates as “barrier” or “quantum dot” lines or gates, respectively, this is simply for ease of discussion, and in other embodiments, the role of “barrier” and “quantum dot” lines and gates may be switched (e.g., barrier gates may instead act as quantum dot gates, and vice versa). FIGS. 1B-1F are side cross-sectional views of the quantum dot device 100 of FIG. 1A; in particular, FIG. 1B is a view through the section B-B of FIG. 1A, FIG. 1C is a view through the section C-C of FIG. 1A, FIG. 1D is a view through the section D-D of FIG. 1A, FIG. 1E is a view through the section E-E of FIG. 1A, and FIG. 1F is a view through the section F-F of FIG. 1A.

The quantum dot device 100 of FIG. 1 may be operated in any of a number of ways. For example, in some embodiments, electrical signals such as voltages, currents, radio frequency (RF), and/or microwave signals, may be provided to one or more first gate line 102, second gate line 104, and/or third gate line 106 to cause a quantum dot (e.g., an electron spin-based quantum dot or a hole spin-based quantum dot) to form in a quantum well stack 146 under a third gate 166 of a third gate line 106. Electrical signals provided to a third gate line 106 may control the electrical potential of a quantum well under the third gates 166 of that third gate line 106, while electrical signals provided to a first gate line 102 (and/or a second gate line 104) may control the potential energy barrier under the first gates 162 of that first gate line 102 (and/or the second gates 164 of that second gate line 104) between adjacent quantum wells. Quantum interactions between quantum dots in different quantum wells in the quantum well stack 146 (e.g., under different quantum dot gates) may be controlled in part by the potential energy barrier provided by the barrier potentials imposed between them (e.g., by intervening barrier gates).

Generally, the quantum dot devices 100 disclosed herein may further include a source of magnetic fields (not shown) that may be used to create an energy difference in the states of a quantum dot (e.g., the spin states of an electron spin-based quantum dot) that are normally degenerate, and the states of the quantum dots (e.g., the spin states) may be manipulated by applying electromagnetic energy to the gates lines to create quantum bits capable of computation. The source of magnetic fields may be one or more magnet lines. Thus, the quantum dot devices 100 disclosed herein may, through controlled application of electromagnetic energy, be able to manipulate the position, number, and quantum state (e.g., spin) of quantum dots in the quantum well stack 146.

In the quantum dot device 100 of FIG. 1, a gate dielectric 114 may be disposed on a quantum well stack 146. A quantum well stack 146 may include at least one quantum well layer (not shown in FIG. 1) in which quantum dots may be localized during operation of the quantum dot device 100. The gate dielectric 114 may be any suitable material, such as a high-k material. Multiple parallel first gate lines 102 may be disposed on the gate dielectric 114, and spacer material 118 may be disposed on side faces of the first gate lines 102. In some embodiments, a patterned hardmask 110 may be disposed on the first gate lines 102 (with the pattern corresponding to the pattern of the first gate lines 102), and the spacer material 118 may extend up the sides of the hardmask 110, as shown. The first gate lines 102 may each be a first gate 162. Different ones of the first gate lines 102 may be electrically controlled in any desired combination (e.g., each first gate line 102 may be separately electrically controlled, or some or all the first gate lines 102 may be shorted together in one or more groups, as desired).

Multiple parallel second gate lines 104 may be disposed over and between the first gate lines 102. As illustrated in FIG. 1, the second gate lines 104 may be arranged perpendicular to the first gate lines 102. The second gate lines 104 may extend over the hardmask 110, and may include second gates 164 that extend down toward the quantum well stack 146 and contact the gate dielectric 114 between adjacent ones of the first gate lines 102, as illustrated in FIG. 1D. In some embodiments, the second gates 164 may fill the area between adjacent ones of the first gate lines 102/spacer material 118 structures; in other embodiments, an insulating material (not shown) may be present between the first gate lines 102/spacer material 118 structures and the proximate second gates 164. In some embodiments, spacer material 118 may be disposed on side faces of the second gate lines 104; in other embodiments, no spacer material 118 may be disposed on side faces of the second gate lines 104. In some embodiments, a hardmask 115 may be disposed above the second gate lines 104. Multiple ones of the second gates 164 of a second gate line 104 are electrically continuous (due to the shared conductive material of the second gate line 104 over the hardmask 110). Different ones of the second gate lines 104 may be electrically controlled in any desired combination (e.g., each second gate line 104 may be separately electrically controlled, or some or all the second gate lines 104 may be shorted together in one or more groups, as desired). Together, the first gate lines 102 and the second gate lines 104 may form a grid, as depicted in FIG. 1.

Multiple parallel third gate lines 106 may be disposed over and between the first gate lines 102 and the second gate lines 104. As illustrated in FIG. 1, the third gate lines 106 may be arranged diagonal to the first gate lines 102, and diagonal to the second gate lines 104. In particular, the third gate lines 106 may be arranged diagonally over the openings in the grid formed by the first gate lines 102 and the second gate lines 104. The third gate lines 106 may include third gates 166 that extend down to the gate dielectric 114 in the openings in the grid formed by the first gate lines 102 and the second gate lines 104; thus, each third gate 166 may be bordered by two different first gate lines 102 and two different second gate lines 104. In some embodiments, the third gates 166 may be bordered by insulating material 128; in other embodiments, the third gates 166 may fill the openings in the grid (e.g., contacting the spacer material 118 disposed on side faces of the adjacent first gate lines 102 and the second gate lines 104, not shown). Additional insulating material 117 may be disposed on and/or around the third gate lines 106. Multiple ones of the third gates 166 of a third gate line 106 are electrically continuous (due to the shared conductive material of the third gate line 106 over the first gate lines 102 and the second gate lines 104). Different ones of the third gate lines 106 may be electrically controlled in any desired combination (e.g., each third gate line 106 may be separately electrically controlled, or some or all the third gate lines 106 may be shorted together in one or more groups, as desired).

Although FIGS. 1A-F illustrate a particular number of first gate lines 102, second gate lines 104, and third gate lines 106, this is simply for illustrative purposes, and any number of first gate lines 102, second gate lines 104, and third gate lines 106 may be included in a quantum dot device 100. Other examples of arrangements of first gate lines 102, second gate lines 104, and third gate lines 106 are possible. Electrical interconnects (e.g., vias and conductive lines) may contact the first gate lines 102, second gate lines 104, and third gate lines 106 in any desired manner.

Not illustrated in FIG. 1 are accumulation regions that may be electrically coupled to the quantum well layer of the quantum well stack 146 (e.g., laterally proximate to the quantum well layer). The accumulation regions may be spaced apart from the gate lines by a thin layer of an intervening dielectric material. The accumulation regions may be regions in which carriers accumulate (e.g., due to doping, or due to the presence of large electrodes that pull carriers into the quantum well layer), and may serve as reservoirs of carriers that can be selectively drawn into the areas of the quantum well layer under the third gates 166 (e.g., by controlling the voltages on the quantum dot gates, the first gates 162, and the second gates 164) to form carrier-based quantum dots (e.g., electron or hole quantum dots, including a single charge carrier, multiple charge carriers, or no charge carriers). In other embodiments, a quantum dot device 100 may not include lateral accumulation regions, but may instead include doped layers within the quantum well stack 146. These doped layers may provide the carriers to the quantum well layer. Any combination of accumulation regions (e.g., doped or non-doped) or doped layers in a quantum well stack 146 may be used in any of the embodiments of the quantum dot devices 100 disclosed herein.

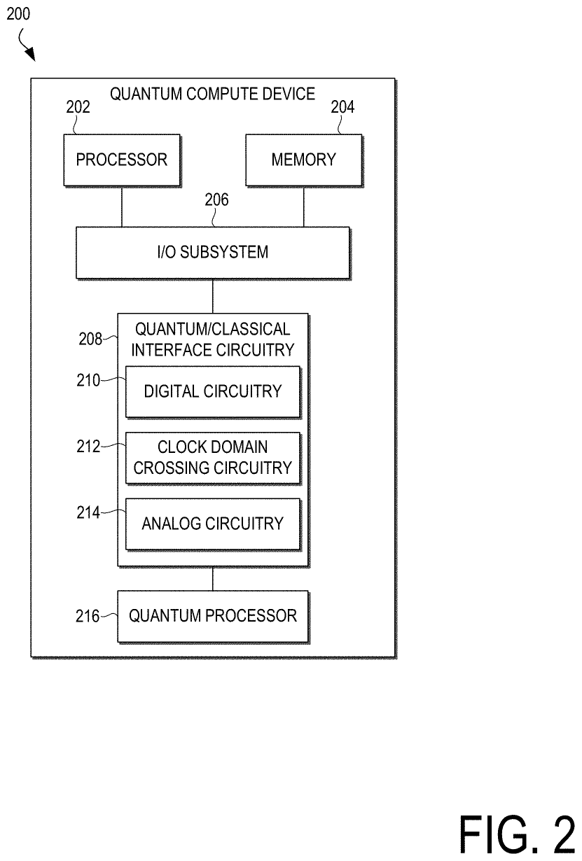

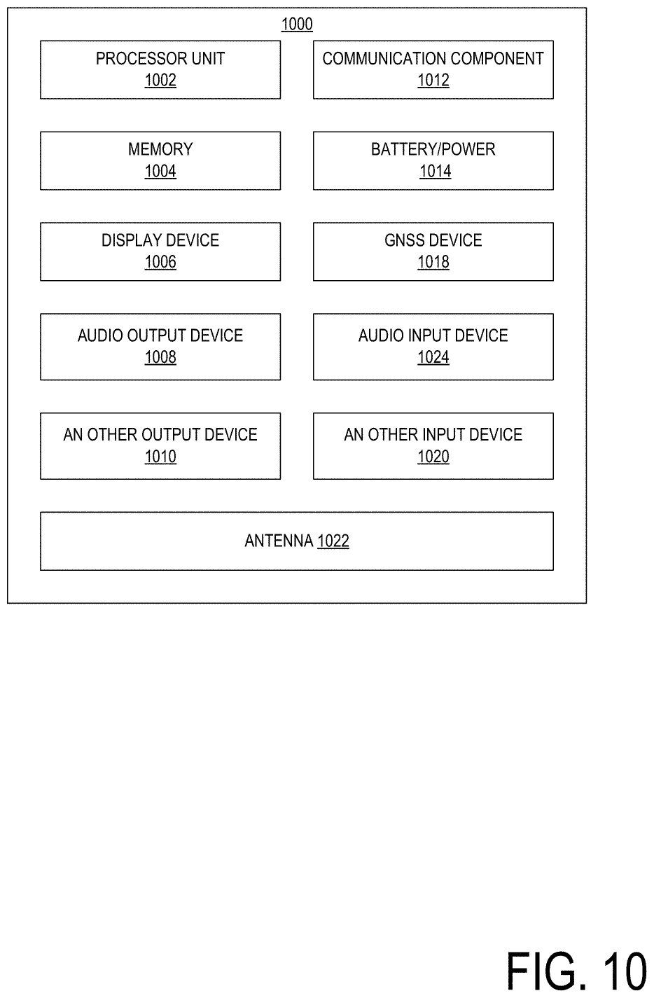

Referring now to FIG. 2, a simplified block diagram of a quantum compute device 200 is shown. In some embodiments, the quantum compute device 200 may include the quantum dot devices 100 described above in regard to FIGS. 1A-1F. The quantum compute device 200 may be embodied as or included in any type of compute device. For example, the quantum compute device 200 may include or otherwise be included in, without limitation, a server computer, an embedded computing system, a System-on-a-Chip (SoC), a multiprocessor system, a processor-based system, a consumer electronic device, a desktop computer, a laptop computer, a network device, a networked computer, a distributed computing system, and/or any other computing device. The illustrative quantum compute device 200 includes a processor 202, a memory 204, an input/output (I/O) subsystem 206, a quantum/classical interface circuitry 208, and a quantum processor 216. In some embodiments, one or more of the illustrative components of the quantum compute device 200 may be incorporated in, or otherwise form a portion of, another component. For example, the memory 204, or portions thereof, may be incorporated in the processor 202 in some embodiments. In some embodiments, the quantum compute device 200 may be embodied as the electrical device 1000 described below in regard to FIG. 10 or may include any suitable component of the electrical device 1000.

In some embodiments, the quantum compute device 200 may be located in a data center with other compute devices, such as an enterprise data center (e.g., a data center owned and operated by a company and typically located on company premises), managed services data center (e.g., a data center managed by a third party on behalf of a company), a colocated data center (e.g., a data center in which data center infrastructure is provided by the data center host and a company provides and manages their own data center components (servers, etc.)), cloud data center (e.g., a data center operated by a cloud services provider that host companies applications and data), and an edge data center (e.g., a data center, typically having a smaller footprint than other data center types, located close to the geographic area that it serves), a micro data center, etc. In some embodiments, the quantum compute device 200 may receive jobs over a network (such as the Internet) to perform on the quantum processor 216. The quantum compute device 200 may perform the jobs on the quantum processor 216 and send the results back to the requesting device.

The processor 202 may be embodied as any type of processor capable of performing the functions described herein. For example, the processor 202 may be embodied as a single or multi-core processor(s), a single or multi-socket processor, a digital signal processor, a graphics processor, a neural network compute engine, an image processor, a microcontroller, or other processor or processing/controlling circuit. The processor 202 may include multiple processor cores. In some embodiments, the processor 202 supports quantum extensions to an existing ISA of the processor/core 202, allowing instructions that interface with the quantum/classical interface circuitry 208 and the quantum processor 216.

The memory 204 may be embodied as any type of volatile or non-volatile memory or data storage capable of performing the functions described herein. In operation, the memory 204 may store various data and software used during operation of the quantum compute device 200, such as operating systems, applications, programs, libraries, and drivers. The memory 204 is communicatively coupled to the processor 202 via the I/O subsystem 206, which may be embodied as circuitry and/or components to facilitate input/output operations with the processor 202, the memory 204, and other components of the quantum compute device 200. For example, the I/O subsystem 206 may be embodied as, or otherwise include, memory controller hubs, input/output control hubs, firmware devices, communication links (e.g., point-to-point links, bus links, wires, cables, light guides, printed circuit board traces, etc.) and/or other components and subsystems to facilitate the input/output operations. The I/O subsystem 206 may connect various internal and external components of the quantum compute device 200 to each other with use of any suitable connector, interconnect, bus, protocol, etc., such as an SoC fabric, PCIe®, USB2, USB3, USB4, NVMe®, Thunderbolt®, Compute Express Link (CXL), and/or the like. In some embodiments, the I/O subsystem 206 may form a portion of a system-on-a-chip (SoC) and be incorporated, along with the processor 202 and the memory 204 and other components of the quantum compute device 200 on a single integrated circuit chip.

The quantum/classical interface circuitry 208 is configured to interface with both classical components of the quantum compute device 200, such as the processor 202 and memory 204, as well as the quantum processor 216. The quantum/classical interface circuitry 208 may include a variety of analog or digital circuitry, such as analog-to-digital converters, digital-to-analog converters, high gain amplifiers, low noise amplifiers, cryogenic amplifiers, field-programmable gate arrays (FPGAs), classical processors, application-specific integrated circuits (ASICs), signal generating circuitry, signal conditioning circuitry, etc. In some embodiments, some or all of the quantum/classical interface circuitry 208 may be inside of a refrigerator, such as a dilution refrigerator, a magnetic refrigerator, a helium-4 and/or helium-3 refrigerator, etc. Some or all of the components of the quantum/classical interface circuitry 208 may be at any suitable temperature, such as 10 millikelvin, 100 millikelvin, 4 Kelvin, 10 Kelvin, 20 Kelvin, 77 Kelvin, room temperature or above, or anywhere in between.

The quantum/classical interface circuitry 208 includes digital circuitry 210, clock domain crossing circuitry 212, and analog circuitry 214. The digital circuitry 210 is configured to interface with the processor 202, memory 204, or other classical parts of the quantum compute device 200. The digital circuitry 210 may include memory, processing components, communication circuitry, etc. The clock domain crossing circuitry 212 is configured to allow high-speed asynchronous data transfer between the digital circuitry 210 and the analog circuitry 214. The analog circuitry 214 is configured to interface with the quantum processor 216 by sending and/or receiving one or more analog signals. The analog circuitry 214 may include, e.g., one or more digital to analog converters, analog to digital converters, radio-frequency (RF) signal generators, amplifiers, filters, frequency mixers, RF splitters, etc. The analog circuitry 214 may include ancillary digital circuitry to assist the analog components of the analog circuitry 214.

The quantum processor 216 is configured to operate one or more qubits. The qubits may be any suitable type of qubit, such as a quantum dot spin qubit described above in regard to FIGS. 1A-1F. In other embodiments, the qubits may be, e.g., charge qubits, transmon qubits, microwave qubits, superconducting qubits, or any other suitable type of qubits. The quantum processor 216 may include any suitable number of physical or logical qubits, such as 1-10⁶. In the illustrative embodiment, some or all of the quantum processor 216 is in a cryogenic refrigerator such as a dilution refrigerator. In particular, in the illustrative embodiment, the qubits are held at a temperature of about 10 millikelvin. In other embodiments, the qubits may be held at any suitable temperature, such as 1-100 millikelvin or higher, depending on the temperature sensitivity of the particular qubit in use.

The quantum processor 216 may be able to control the various qubits in various ways, such as by performing two-qubit gates, three-qubit gates, error correction operations, transferring a state from one type of qubit to another, measuring some, any or, all of the qubits, initializing some, any, or all of the qubits, etc.

The quantum compute device 200 may include additional components not shown in FIG. 2, such as one or more data storage devices, a network interface controller, one or more peripheral devices, etc.

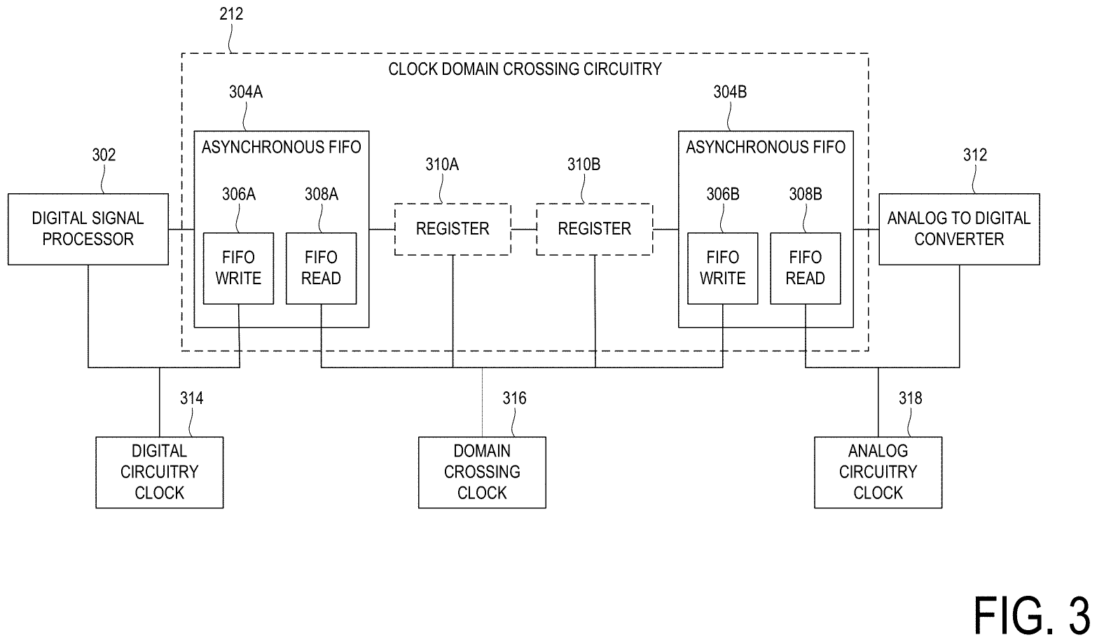

Referring now to FIG. 3, various components of the classical/quantum interface circuitry of FIG. 2 are shown. The clock domain crossing circuitry 212 allows a digital signal processor 302 of the digital circuitry 210 to communicate with a digital to analog converter (DAC) 312 of the analog circuitry 214. The digital signal processor 302 operates on a digital circuitry clock 314, some components of the clock domain crossing circuitry 212 operate on a domain crossing clock 316, and the DAC 312 operates on an analog circuitry clock 318.

The claim domain crossing circuitry 212 includes a first asynchronous FIFO queue 304A and a second asynchronous FIFO queue 304B, connected by one or more optional registers 310A, 310B. The first asynchronous FIFO queue 304A includes a FIFO write 306A and a FIFO read 308A, which are driven by the digital circuitry clock 314 and domain crossing clock 316, respectively. The second asynchronous FIFO queue 304A similarly includes a FIFO write 306B and a FIFO read 308B, which are driven by the domain crossing clock 316 and analog circuitry clock 318, respectively. In use, the digital signal processor 302 writes data to the FIFO write 306A. The FIFO read 308A reads that data and sends it to the FIFO write 306B. The FIFO read 306B reads the data and sends it to the DAC 312. Each of the clocks 314, 316, 318 may operate at any suitable frequency, such as 1 kilohertz to 5 gigahertz.

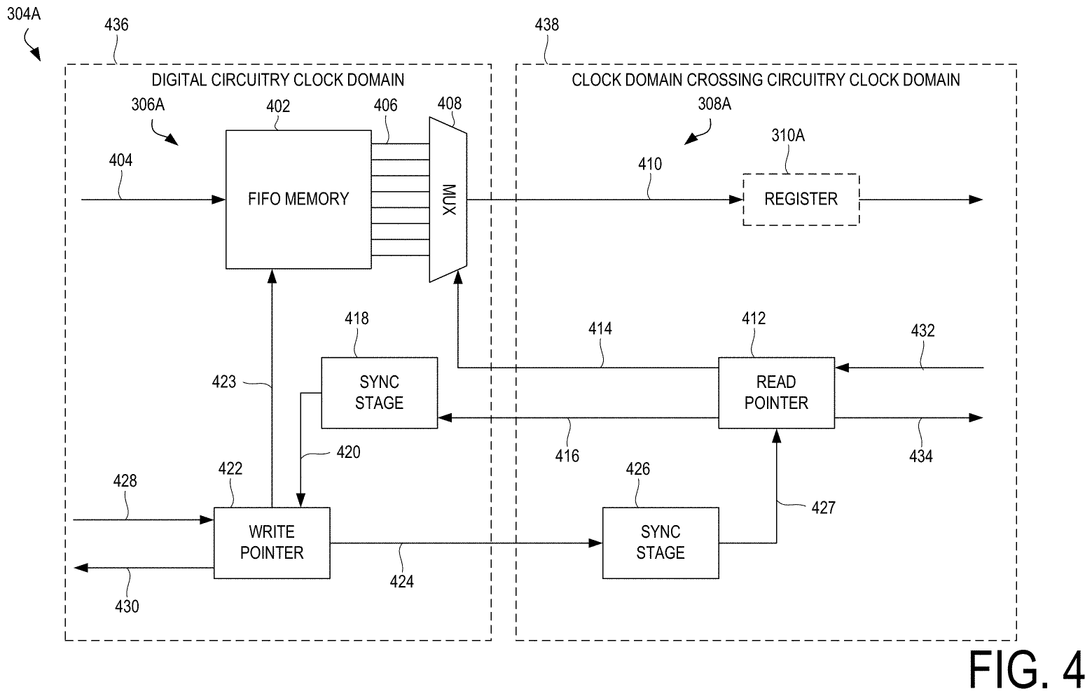

Referring now to FIG. 4, in one embodiment, a more detailed circuit diagram of some of the components shown in FIG. 3 is shown. The FIFO write 306A includes a FIFO memory 402 to store data to be sent to the FIFO read 308A. A write data bus 404 provides data to be written to the FIFO memory 402. The width of the bus 404 (and other buses 406, 410 carrying the data) may be any suitable width, such as 8-512 bits. An array of buses 406 extend from the FIFO memory 402 to a multiplexer (MUX) 408. The array of buses 406 includes a bus 406 for each memory location of the FIFO memory 402, allowing the FIFO read 308A to access any memory location at the MUX 408.

In some embodiments, a bus 410 connects the selected output of the MUX 408 directly to the next FIFO queue 304B. In other embodiments, if the time for the signal to travel the distance from the MUX 408 to the FIFO queue 304B is too long relative to the time of one clock cycle of the domain crossing clock 316, one or more registers 310A may be placed along the bus 410. The bus 410 together with the registers 310 and any other suitable intervening components acts as an interconnect between the first FIFO queue 304A and the second FIFO queue 304B.

The memory location selected by the MUX 408 is controlled by a connection 414 from a read pointer 412. The read pointer is incremented after each read, cycling through the memory locations of the FIFO memory 402. The read memory address is provided by a connection 416 to a sync stage 418 and then provided for reference to a write pointer 422. In the illustrative embodiment, the read memory address is provided in a Gray code format so that only one bit changes when the read pointer 412 increments.

The write pointer 422 indicates by a connection 423 the next write address that should be written to in the FIFO memory 402. The write pointer 422 also provides the write address by a connection 424 to another sync stage 426, which then provides the write address by a connection 427 to the read pointer 412. In the illustrative embodiment, the write pointer 422 provides the write address to the sync stage 426 in a Gray code format.

A push connection 428 indicates to the write pointer 422 and/or the FIFO memory 402 that data on the bus 404 should be written to the next memory location in the FIFO memory 402 indicated by the address of the write pointer 422 and that the address of the write pointer should be incremented. A full connection 430 indicates to control circuitry that the FIFO memory 402 is full and that push commands should not be sent on the push connection 428. The indication from the full connection 430 can be used to provide backpressure with clock cycle granularity as well as data flow synchronization between different throughput data paths. Similarly, a pop connection 432 indicates to the read pointer 412 that the address of the read pointer 412 should be read and the address of the read pointer 412 should be incremented. An empty connection 434 indicates to control circuitry that the FIFO memory 402 is empty and a pop command should not be sent.

In use, the asynchronous FIFO queue 304A is configured to allow for high-speed data transfer without bubbles (i.e., empty data slots) in the data transfer stream. Due to latency from various flows such as the time from the FIFO read 308A beginning to read data from a full FIFO memory 402 to when the FIFO write 306A begins writing to the FIFO memory 402, the FIFO memory 402 may require a minimum depth, such as any suitable depth from 2-32.

In the illustrative embodiment, some of the components shown in FIG. 4 operate in a digital circuitry clock domain 436 and are clocked by the digital circuitry clock 314, while other components operate in a clock domain crossing circuitry clock domain and are clocked by the domain crossing clock 316.

The clock domain crossing circuitry 212 may operate in a variety of clock configurations. For example, in one embodiment, the analog circuitry clock 318, the domain crossing clock 316, and the digital circuitry clock 314 are all asynchronous. In another embodiment, the domain crossing clock 316 may be identical or synchronous to the digital circuitry clock 314 or the analog circuitry clock 318. In another embodiment, the analog circuitry clock 318 may be synchronous to the digital circuitry clock 314 and/or the domain crossing clock 316 but at a different frequency, such as one half or twice the frequency. In another embodiment, the digital circuitry clock 314, the domain crossing clock 316, and the analog circuitry clock 318 may be identical. In another embodiment, with an identical clock shared by the digital circuitry 210 and the analog circuitry 214, the asynchronous FIFO queues 304A, 304B may be bypassed entirely. The FIFO queues 304A, 304B may still be present, as removing them from the design of the circuit may be more complex than leaving them present, if unused. In some embodiments, the configuration of the various clocks 314, 316, 318 may be indicated by a value of one or more registers. In such embodiments, the clock domain crossing circuitry 212 may be configured based on the value of the one or more registers.

In the illustrative embodiment, each sync stage 418, 426 includes one or more flip flops. If the first flip flop enters a metastable state due to a setup/hold violation, the second flip flop can give the first enough time to exit the metastable state. The number of flip flops used may depend on the clock configuration. For example, if the clock for the FIFO write 306 is asynchronous to the clock for the FIFO read 308, two flip flops may be used. In some embodiments, three flip flops may be used to reduce the probability of rare errors. If the clock for the FIFO write 306 is synchronous to the clock for the FIFO read 308 but at a different frequency, one flip flop may be used. If the clock for the FIFO write 306 is identical to the clock for the FIFO read 308, no flip flops may be used and the sync stages 418, 426 may not be used.

The FIFO queue 304B is similar to the FIFO queue 304A shown in FIG. 4. However, the FIFO queue 304B needs to have a depth that depends on the number of registers 310 between the FIFO queue 304A and FIFO queue 304B, as the FIFO queue 304B needs to be able to store the data that is traveling through the registers 310 when the indication on the pop connection 432 indicates that data should stop being read (due to, e.g., the FIFO memory 402 of the FIFO queue 304B getting close to full).

In the illustrative embodiment shown, the data path is from the digital circuitry 210 to the analog circuitry 214. Additionally or alternatively, in some embodiments, the data path may be from the analog circuitry 214 to the digital circuitry 210. In the illustrative embodiment, the data path is from digital circuitry 210 to analog circuitry 214 on the same die. In other embodiments, the data path may be from digital circuitry 210 on one die to analog circuitry 214 on a different die in the same package, or the data path may be from digital circuitry 210 on one package to analog circuitry 214 on a different package. The digital circuitry 210 and analog circuitry 214 on the same die may be any suitable distance apart, such as 10 micrometers to 10 millimeters.

It should be appreciated that the clock domain crossing circuitry 212 may include additional components or connections not shown in FIGS. 3 and 4, such as indications of how much the FIFO memory 402 is, additional control circuitry or control connections, etc.

In some embodiments, the clock domain crossing circuitry 212 may be implemented in a relatively high-level hardware description language. Such an implementation may have parameters indicating, e.g., the clock synchronization between the digital circuitry 210 and the analog circuitry 214, and the compiled version of the clock domain crossing circuitry 212 may be adjusted based on those parameters, such as by adjusting the number of flip flops in the sync stages 418, 426 or by adjusting the depth of the memory in the FIFO memory 402.

In some embodiments, when the clock domain crossing circuitry 212 is powered on, the output of the FIFO memory 402 may be a random value. For example, in some embodiments, flip flops storing memory values in the FIFO memory 402 may be non-resettable flip flops in order to save space. In such embodiments, a register (or compile-time parameter) may store a desired default value to be outputted by the FIFO memory 402 before any data is written to it, such as all zeros or all ones.

In some embodiments, the memory depth of the FIFO memory 402 may be controlled using a compile-time parameter or a register. A compile-time parameter will allow for a smaller, lower-power FIFO memory 402 when possible. A register may allow for real-time adjustment in the memory depth of the FIFO memory 402, reducing the required power to maintain the memory.

In some embodiments, the side receiving data may be powered off until a signal (e.g., a change to the empty connection 434) indicates that there is data to receive. Such a signal may cause the receiving side to power on. In some embodiments, such a configuration may result in the receiving side being temporally synchronized to the clock of the sending side. For example, if the receiving side operates a clock at half a frequency of a reference clock, the clock of receiving side may have two possible states relative to the reference clock. If the signal indicating that data is present triggers the clock on the receiving side to turn on, it can automatically synchronize the receiving clock to the desired state. Such an approach may be used to, e.g., remove any uncertainty in the timing of data received by the digital circuitry 210 from the analog circuitry 214.

It should be appreciated that the illustrative embodiment of the clock domain crossing circuitry 212 connecting digital circuitry 210 to analog circuitry 214 is merely one possible embodiment. In other embodiments, the clock domain crossing circuitry 212 may connect digital circuitry to digital circuitry, analog circuitry to analog circuitry, or connect any other suitable combination of circuitry.

It should be appreciated that the circuits shown in FIGS. 3 and 4 can operate in a wide range of clock frequencies without any changes. For example, if the digital circuitry clock 314 has a nominal frequency of, e.g., one gigahertz, the clock domain crossing circuitry 212 will still operate if the digital circuitry clock 314 is changed to, e.g., 750 or 500 megahertz.

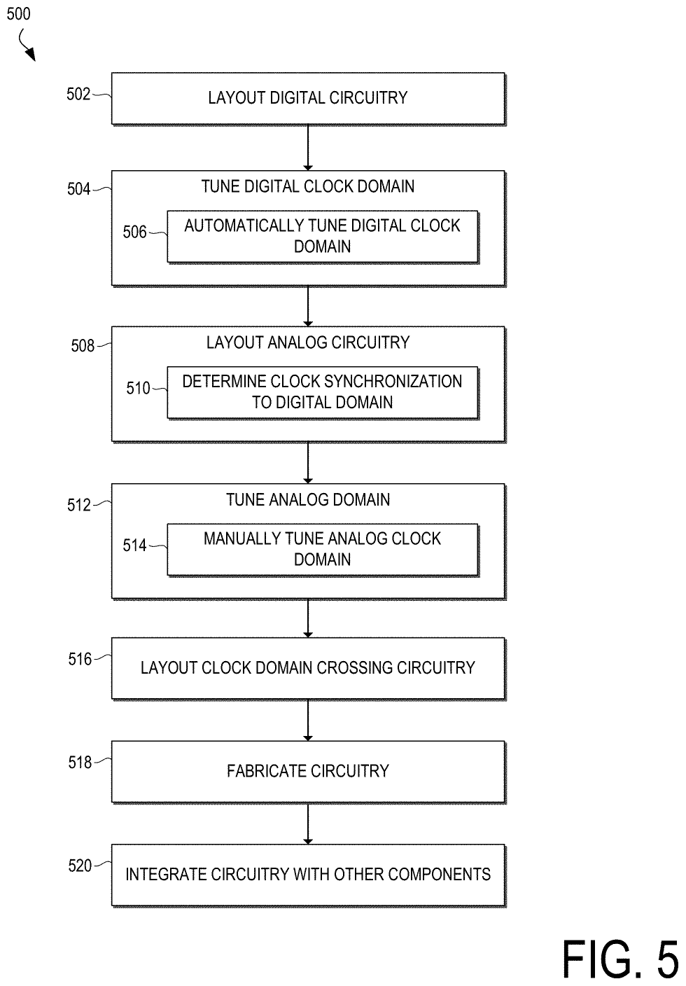

Referring now to FIG. 5, in one embodiment, a flowchart for a method 500 for designing and fabricating the quantum/classical interface circuitry 208 is shown. Any suitable step of the method 500 may be executed or performed by a person such as an engineer or technician and/or by one or more automated machines. The method 500 may use any suitable set of techniques that are used in semiconductor processing, such as chemical vapor deposition, atomic layer deposition, physical layer deposition, molecular beam epitaxy, layer transfer, photolithography, ion implantation, dry etching, wet etching, thermal treatments, flip chip, layer transfer, magnetron sputter deposition, pulsed laser deposition, etc. It should be appreciated that the method 500 is merely one embodiment of a method to design and fabricating the quantum/classical interface circuitry 208, and other methods may be used to create the quantum/classical interface circuitry 208. In some embodiments, steps of the method 500 may be performed in a different order than that shown in the flowchart.

The method 500 begins in block 502, in which the digital circuitry 210 is laid out. An engineer or other person may use software to create a representation of the digital circuitry 210 and include various components, interconnects, etc. In block 504, the components in the digital circuitry clock domain 436 are tuned to, e.g., satisfy certain clock constraints, such as by adjusting a clock tree, adjusting signal paths to align the clock at the various components, etc. In block 506, in the illustrative embodiment, the components in the digital circuitry clock domain 436 are tuned automatically using software.

In block 508, the analog circuitry 214 is laid out. An engineer or other person may use software to create a representation of the analog circuitry 214 and include various components, interconnects, etc. In block 510, the clock synchronization to the digital clock domain is determined. For example, the analog clock domain may be identical to, synchronous to, asynchronous to the digital clock domain. In the illustrative embodiment, the layout of some components of the analog circuitry 214 and/or digital circuitry 210 may change based on the clock synchronization to the digital clock domain. For example, the number of flip flops in the sync stages 418, 426 may change based on the clock synchronization to the digital clock domain.

In block 512, the components in the analog circuitry clock domain are tuned to, e.g., satisfy certain clock constraints, such as by adjusting signal paths to align the clock at the various components. In block 514, in the illustrative embodiment, the components in the analog circuitry clock domain are tuned manually by, e.g., an engineer or other person manually adjusting a clock tree, adjusting circuit paths to achieve desired timing, etc. In other embodiments, the components in the analog circuitry clock domain may be tuned automatically.

In block 516, the clock domain crossing circuitry 212 is laid out. The clock domain crossing circuitry 212 may be laid out by an engineer or other person using software tools. In one embodiment, the clock domain crossing circuitry 212 can be considered a module that can be used to connect the digital circuitry 210 to the analog circuitry 214 by specifying certain parameters, such as the clock synchronization. The specific configuration of, e.g., the depth of the FIFO memory 402, the number of flip flops in the sync stages 418, 426, etc., of the resulting circuitry may be controlled using those parameters. The clock domain crossing circuitry 212 may be automatically tuned by, e.g., adjusting signal paths to align the clock at various components.

After design of the quantum/classical interface circuitry 208 is complete, the quantum/classical interface circuitry 208 may be fabricated in block 518. In some embodiments, the quantum/classical interface circuitry 208 may be fabricated on one die. In other embodiments, quantum/classical interface circuitry 208 may be fabricated on more than one die and packaged together or may be fabricated on more than one die and packaged in more than one package.

In block 520, the quantum/classical interface circuitry 208 is integrated with other components, such as the quantum processor 216, the processor 202, the memory 204, etc., to assemble the quantum compute device 200.

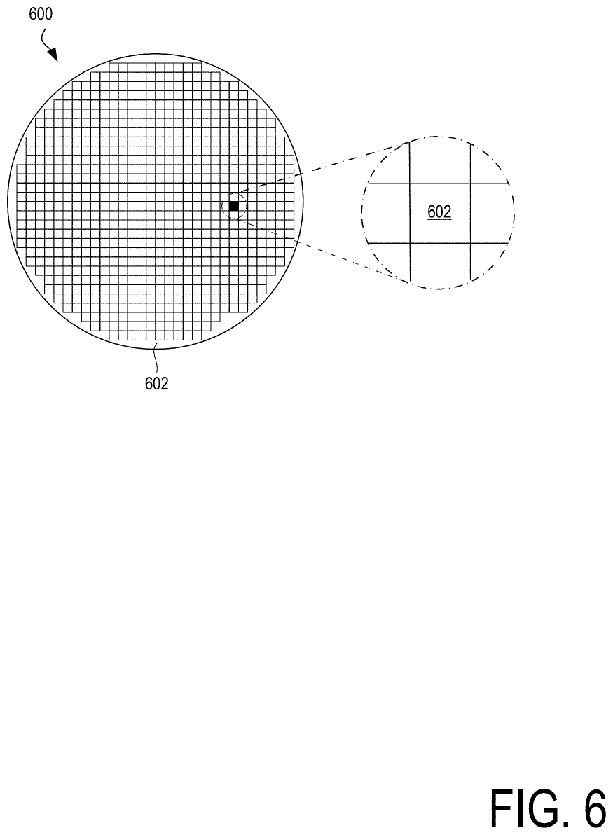

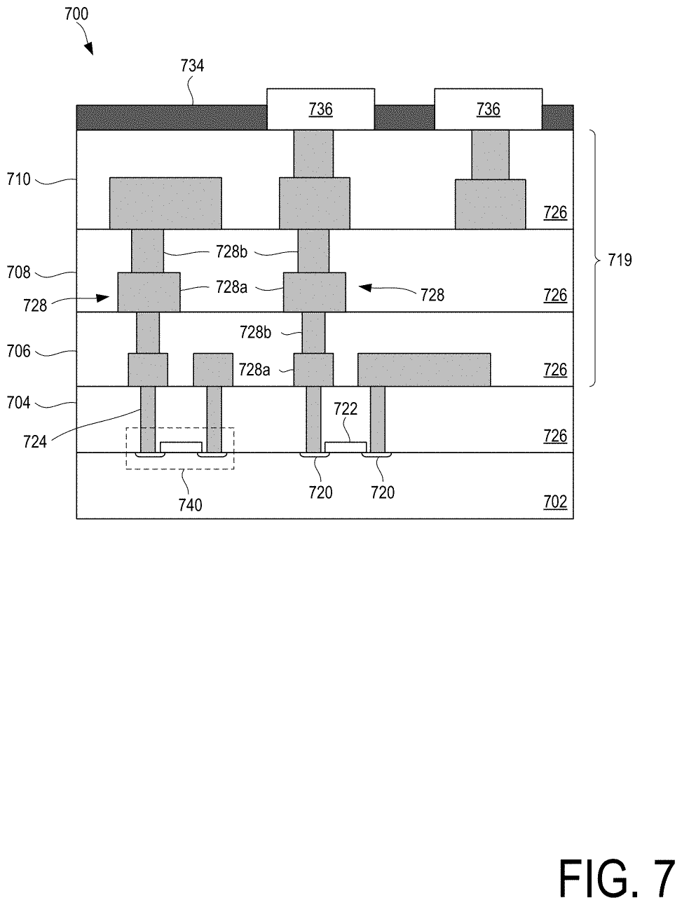

FIG. 6 is a top view of a wafer 600 and dies 602 that may include any of the circuitry disclosed herein (e.g., the digital circuitry 210, the clock domain crossing circuitry 212, the analog circuitry 214). The wafer 600 may be composed of semiconductor material and may include one or more dies 602 having integrated circuit structures formed on a surface of the wafer 600. The individual dies 602 may be a repeating unit of an integrated circuit product that includes any suitable integrated circuit. After the fabrication of the semiconductor product is complete, the wafer 600 may undergo a singulation process in which the dies 602 are separated from one another to provide discrete “chips” of the integrated circuit product. The die 602 may include one or more transistors (e.g., some of the transistors 740 of FIG. 7, discussed below), supporting circuitry to route electrical signals to the transistors, passive components (e.g., signal traces, resistors, capacitors, or inductors), and/or any other integrated circuit components. In some embodiments, the wafer 600 or the die 602 may include a memory device (e.g., a random access memory (RAM) device, such as a static RAM (SRAM) device, a magnetic RAM (MRAM) device, a resistive RAM (RRAM) device, a conductive-bridging RAM (CBRAM) device, etc.), a logic device (e.g., an AND, OR, NAND, or NOR gate), or any other suitable circuit element. Multiple ones of these devices may be combined on a single die 602. For example, a memory array formed by multiple memory devices may be formed on a same die 602 as a processor unit (e.g., the processor unit 1002 of FIG. 10) or other logic that is configured to store information in the memory devices or execute instructions stored in the memory array. Various ones of the circuitry disclosed herein may be manufactured using a die-to-wafer assembly technique in which some dies are attached to a wafer 600 that include others of the dies, and the wafer 600 is subsequently singulated.

FIG. 7 is a cross-sectional side view of an integrated circuit device 700 that may include in any of the circuitry disclosed herein (e.g., the digital circuitry 210, the clock domain crossing circuitry 212, the analog circuitry 214). One or more of the integrated circuit devices 700 may be included in one or more dies 602 (FIG. 6). The integrated circuit device 700 may be formed on a die substrate 702 (e.g., the wafer 600 of FIG. 6) and may be included in a die (e.g., the die 602 of FIG. 6). The die substrate 702 may be a semiconductor substrate composed of semiconductor material systems including, for example, n-type or p-type materials systems (or a combination of both). The die substrate 702 may include, for example, a crystalline substrate formed using a bulk silicon or a silicon-on-insulator (SOI) substructure. In some embodiments, the die substrate 702 may be formed using alternative materials, which may or may not be combined with silicon, that include, but are not limited to, germanium, indium antimonide, lead telluride, indium arsenide, indium phosphide, gallium arsenide, or gallium antimonide. Further materials classified as group II-VI, III-V, or IV may also be used to form the die substrate 702. Although a few examples of materials from which the die substrate 702 may be formed are described here, any material that may serve as a foundation for an integrated circuit device 700 may be used. The die substrate 702 may be part of a singulated die (e.g., the dies 602 of FIG. 6) or a wafer (e.g., the wafer 600 of FIG. 6).

The integrated circuit device 700 may include one or more device layers 704 disposed on the die substrate 702. The device layer 704 may include features of one or more transistors 740 (e.g., metal oxide semiconductor field-effect transistors (MOSFETs)) formed on the die substrate 702. The transistors 740 may include, for example, one or more source and/or drain (S/D) regions 720, a gate 722 to control current flow between the S/D regions 720, and one or more S/D contacts 724 to route electrical signals to/from the S/D regions 720. The transistors 740 may include additional features not depicted for the sake of clarity, such as device isolation regions, gate contacts, and the like. The transistors 740 are not limited to the type and configuration depicted in FIG. 7 and may include a wide variety of other types and configurations such as, for example, planar transistors, non-planar transistors, or a combination of both. Non-planar transistors may include FinFET transistors, such as double-gate transistors or tri-gate transistors, and wrap-around or all-around gate transistors, such as nanoribbon, nanosheet, or nanowire transistors.

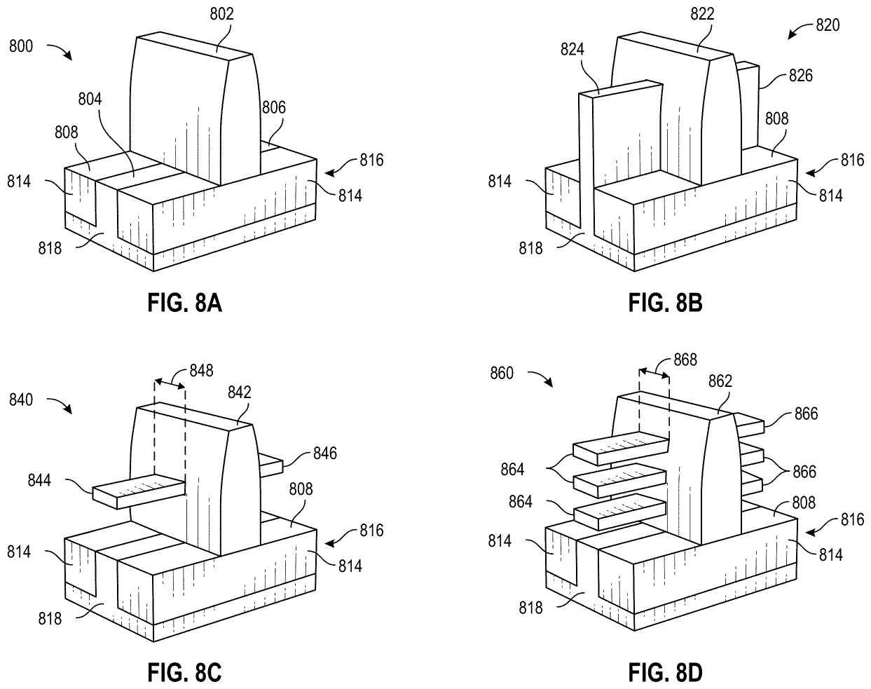

FIGS. 8A-8D are simplified perspective views of example planar, FinFET, gate-all-around, and stacked gate-all-around transistors. The transistors illustrated in FIGS. 8A-8D are formed on a substrate 816 having a surface 808. Isolation regions 814 separate the source and drain regions of the transistors from other transistors and from a bulk region 818 of the substrate 816.

FIG. 8A is a perspective view of an example planar transistor 800 comprising a gate 802 that controls current flow between a source region 804 and a drain region 806. The transistor 800 is planar in that the source region 804 and the drain region 806 are planar with respect to the substrate surface 808.

FIG. 8B is a perspective view of an example FinFET transistor 820 comprising a gate 822 that controls current flow between a source region 824 and a drain region 826. The transistor 820 is non-planar in that the source region 824 and the drain region 826 comprise “fins” that extend upwards from the substrate surface 828. As the gate 822 encompasses three sides of the semiconductor fin that extends from the source region 824 to the drain region 826, the transistor 820 can be considered a tri-gate transistor. FIG. 8B illustrates one S/D fin extending through the gate 822, but multiple S/D fins can extend through the gate of a FinFET transistor.

FIG. 8C is a perspective view of a gate-all-around (GAA) transistor 840 comprising a gate 842 that controls current flow between a source region 844 and a drain region 846. The transistor 840 is non-planar in that the source region 844 and the drain region 846 are elevated from the substrate surface 828.

FIG. 8D is a perspective view of a GAA transistor 860 comprising a gate 862 that controls current flow between multiple elevated source regions 864 and multiple elevated drain regions 866. The transistor 860 is a stacked GAA transistor as the gate controls the flow of current between multiple elevated S/D regions stacked on top of each other. The transistors 840 and 860 are considered gate-all-around transistors as the gates encompass all sides of the semiconductor portions that extends from the source regions to the drain regions. The transistors 840 and 860 can alternatively be referred to as nanowire, nanosheet, or nanoribbon transistors depending on the width (e.g., widths 848 and 868 of transistors 840 and 860, respectively) of the semiconductor portions extending through the gate.

Returning to FIG. 7, a transistor 740 may include a gate 722 formed of at least two layers, a gate dielectric and a gate electrode. The gate dielectric may include one layer or a stack of layers. The one or more layers may include silicon oxide, silicon dioxide, silicon carbide, and/or a high-k dielectric material.

The high-k dielectric material may include elements such as hafnium, silicon, oxygen, titanium, tantalum, lanthanum, aluminum, zirconium, barium, strontium, yttrium, lead, scandium, niobium, and zinc. Examples of high-k materials that may be used in the gate dielectric include, but are not limited to, hafnium oxide, hafnium silicon oxide, lanthanum oxide, lanthanum aluminum oxide, zirconium oxide, zirconium silicon oxide, tantalum oxide, titanium oxide, barium strontium titanium oxide, barium titanium oxide, strontium titanium oxide, yttrium oxide, aluminum oxide, lead scandium tantalum oxide, and lead zinc niobate. In some embodiments, an annealing process may be carried out on the gate dielectric to improve its quality when a high-k material is used.

The gate electrode may be formed on the gate dielectric and may include at least one p-type work function metal or n-type work function metal, depending on whether the transistor 740 is to be a p-type metal oxide semiconductor (PMOS) or an n-type metal oxide semiconductor (NMOS) transistor. In some implementations, the gate electrode may consist of a stack of two or more metal layers, where one or more metal layers are work function metal layers and at least one metal layer is a fill metal layer. Further metal layers may be included for other purposes, such as a barrier layer.

For a PMOS transistor, metals that may be used for the gate electrode include, but are not limited to, ruthenium, palladium, platinum, cobalt, nickel, conductive metal oxides (e.g., ruthenium oxide), and any of the metals discussed below with reference to an NMOS transistor (e.g., for work function tuning). For an NMOS transistor, metals that may be used for the gate electrode include, but are not limited to, hafnium, zirconium, titanium, tantalum, aluminum, alloys of these metals, carbides of these metals (e.g., hafnium carbide, zirconium carbide, titanium carbide, tantalum carbide, and aluminum carbide), and any of the metals discussed above with reference to a PMOS transistor (e.g., for work function tuning).

In some embodiments, when viewed as a cross-section of the transistor 740 along the source-channel-drain direction, the gate electrode may consist of a U-shaped structure that includes a bottom portion substantially parallel to the surface of the die substrate 702 and two sidewall portions that are substantially perpendicular to the top surface of the die substrate 702. In other embodiments, at least one of the metal layers that form the gate electrode may simply be a planar layer that is substantially parallel to the top surface of the die substrate 702 and does not include sidewall portions substantially perpendicular to the top surface of the die substrate 702. In other embodiments, the gate electrode may consist of a combination of U-shaped structures and planar, non-U-shaped structures. For example, the gate electrode may consist of one or more U-shaped metal layers formed atop one or more planar, non-U-shaped layers.

In some embodiments, a pair of sidewall spacers may be formed on opposing sides of the gate stack to bracket the gate stack. The sidewall spacers may be formed from materials such as silicon nitride, silicon oxide, silicon carbide, silicon nitride doped with carbon, and silicon oxynitride. Processes for forming sidewall spacers are well known in the art and generally include deposition and etching process steps. In some embodiments, a plurality of spacer pairs may be used; for instance, two pairs, three pairs, or four pairs of sidewall spacers may be formed on opposing sides of the gate stack.

The S/D regions 720 may be formed within the die substrate 702 adjacent to the gate 722 of individual transistors 740. The S/D regions 720 may be formed using an implantation/diffusion process or an etching/deposition process, for example. In the former process, dopants such as boron, aluminum, antimony, phosphorous, or arsenic may be ion-implanted into the die substrate 702 to form the S/D regions 720. An annealing process that activates the dopants and causes them to diffuse farther into the die substrate 702 may follow the ion-implantation process. In the latter process, the die substrate 702 may first be etched to form recesses at the locations of the S/D regions 720. An epitaxial deposition process may then be carried out to fill the recesses with material that is used to fabricate the S/D regions 720. In some implementations, the S/D regions 720 may be fabricated using a silicon alloy such as silicon germanium or silicon carbide. In some embodiments, the epitaxially deposited silicon alloy may be doped in situ with dopants such as boron, arsenic, or phosphorous. In some embodiments, the S/D regions 720 may be formed using one or more alternate semiconductor materials such as germanium or a group III-V material or alloy. In further embodiments, one or more layers of metal and/or metal alloys may be used to form the S/D regions 720.

Electrical signals, such as power and/or input/output (I/O) signals, may be routed to and/or from the devices (e.g., transistors 740) of the device layer 704 through one or more interconnect layers disposed on the device layer 704 (illustrated in FIG. 7 as interconnect layers 706-710). For example, electrically conductive features of the device layer 704 (e.g., the gate 722 and the S/D contacts 724) may be electrically coupled with the interconnect structures 728 of the interconnect layers 706-710. The one or more interconnect layers 706-710 may form a metallization stack (also referred to as an “ILD stack”) 719 of the integrated circuit device 700.

The interconnect structures 728 may be arranged within the interconnect layers 706-710 to route electrical signals according to a wide variety of designs; in particular, the arrangement is not limited to the particular configuration of interconnect structures 728 depicted in FIG. 7. Although a particular number of interconnect layers 706-710 is depicted in FIG. 7, embodiments of the present disclosure include integrated circuit devices having more or fewer interconnect layers than depicted.

In some embodiments, the interconnect structures 728 may include lines 728a and/or vias 728b filled with an electrically conductive material such as a metal. The lines 728a may be arranged to route electrical signals in a direction of a plane that is substantially parallel with a surface of the die substrate 702 upon which the device layer 704 is formed. For example, the lines 728a may route electrical signals in a direction in and out of the page and/or in a direction across the page. The vias 728b may be arranged to route electrical signals in a direction of a plane that is substantially perpendicular to the surface of the die substrate 702 upon which the device layer 704 is formed. In some embodiments, the vias 728b may electrically couple lines 728a of different interconnect layers 706-710 together.

The interconnect layers 706-710 may include a dielectric material 726 disposed between the interconnect structures 728, as shown in FIG. 7. In some embodiments, dielectric material 726 disposed between the interconnect structures 728 in different ones of the interconnect layers 706-710 may have different compositions; in other embodiments, the composition of the dielectric material 726 between different interconnect layers 706-710 may be the same. The device layer 704 may include a dielectric material 726 disposed between the transistors 740 and a bottom layer of the metallization stack as well. The dielectric material 726 included in the device layer 704 may have a different composition than the dielectric material 726 included in the interconnect layers 706-710; in other embodiments, the composition of the dielectric material 726 in the device layer 704 may be the same as a dielectric material 726 included in any one of the interconnect layers 706-710.

A first interconnect layer 706 (referred to as Metal 1 or “M1”) may be formed directly on the device layer 704. In some embodiments, the first interconnect layer 706 may include lines 728a and/or vias 728b, as shown. The lines 728a of the first interconnect layer 706 may be coupled with contacts (e.g., the S/D contacts 724) of the device layer 704. The vias 728b of the first interconnect layer 706 may be coupled with the lines 728a of a second interconnect layer 708.

The second interconnect layer 708 (referred to as Metal 2 or “M2”) may be formed directly on the first interconnect layer 706. In some embodiments, the second interconnect layer 708 may include via 728b to couple the lines 728 of the second interconnect layer 708 with the lines 728a of a third interconnect layer 710. Although the lines 728a and the vias 728b are structurally delineated with a line within individual interconnect layers for the sake of clarity, the lines 728a and the vias 728b may be structurally and/or materially contiguous (e.g., simultaneously filled during a dual-damascene process) in some embodiments.

The third interconnect layer 710 (referred to as Metal 3 or “M3”) (and additional interconnect layers, as desired) may be formed in succession on the second interconnect layer 708 according to similar techniques and configurations described in connection with the second interconnect layer 708 or the first interconnect layer 706. In some embodiments, the interconnect layers that are “higher up” in the metallization stack 719 in the integrated circuit device 700 (i.e., farther away from the device layer 704) may be thicker that the interconnect layers that are lower in the metallization stack 719, with lines 728a and vias 728b in the higher interconnect layers being thicker than those in the lower interconnect layers.

The integrated circuit device 700 may include a solder resist material 734 (e.g., polyimide or similar material) and one or more conductive contacts 736 formed on the interconnect layers 706-710. In FIG. 7, the conductive contacts 736 are illustrated as taking the form of bond pads. The conductive contacts 736 may be electrically coupled with the interconnect structures 728 and configured to route the electrical signals of the transistor(s) 740 to external devices. For example, solder bonds may be formed on the one or more conductive contacts 736 to mechanically and/or electrically couple an integrated circuit die including the integrated circuit device 700 with another component (e.g., a printed circuit board). The integrated circuit device 700 may include additional or alternate structures to route the electrical signals from the interconnect layers 706-710; for example, the conductive contacts 736 may include other analogous features (e.g., posts) that route the electrical signals to external components.

In some embodiments in which the integrated circuit device 700 is a double-sided die, the integrated circuit device 700 may include another metallization stack (not shown) on the opposite side of the device layer(s) 704. This metallization stack may include multiple interconnect layers as discussed above with reference to the interconnect layers 706-710, to provide conductive pathways (e.g., including conductive lines and vias) between the device layer(s) 704 and additional conductive contacts (not shown) on the opposite side of the integrated circuit device 700 from the conductive contacts 736.

In other embodiments in which the integrated circuit device 700 is a double-sided die, the integrated circuit device 700 may include one or more through silicon vias (TSVs) through the die substrate 702; these TSVs may make contact with the device layer(s) 704, and may provide conductive pathways between the device layer(s) 704 and additional conductive contacts (not shown) on the opposite side of the integrated circuit device 700 from the conductive contacts 736. In some embodiments, TSVs extending through the substrate can be used for routing power and ground signals from conductive contacts on the opposite side of the integrated circuit device 700 from the conductive contacts 736 to the transistors 740 and any other components integrated into the die 700, and the metallization stack 719 can be used to route I/O signals from the conductive contacts 736 to transistors 740 and any other components integrated into the die 700.

Multiple integrated circuit devices 700 may be stacked with one or more TSVs in the individual stacked devices providing connection between one of the devices to any of the other devices in the stack. For example, one or more high-bandwidth memory (HBM) integrated circuit dies can be stacked on top of a base integrated circuit die and TSVs in the HBM dies can provide connection between the individual HBM and the base integrated circuit die. Conductive contacts can provide additional connections between adjacent integrated circuit dies in the stack. In some embodiments, the conductive contacts can be fine-pitch solder bumps (microbumps).

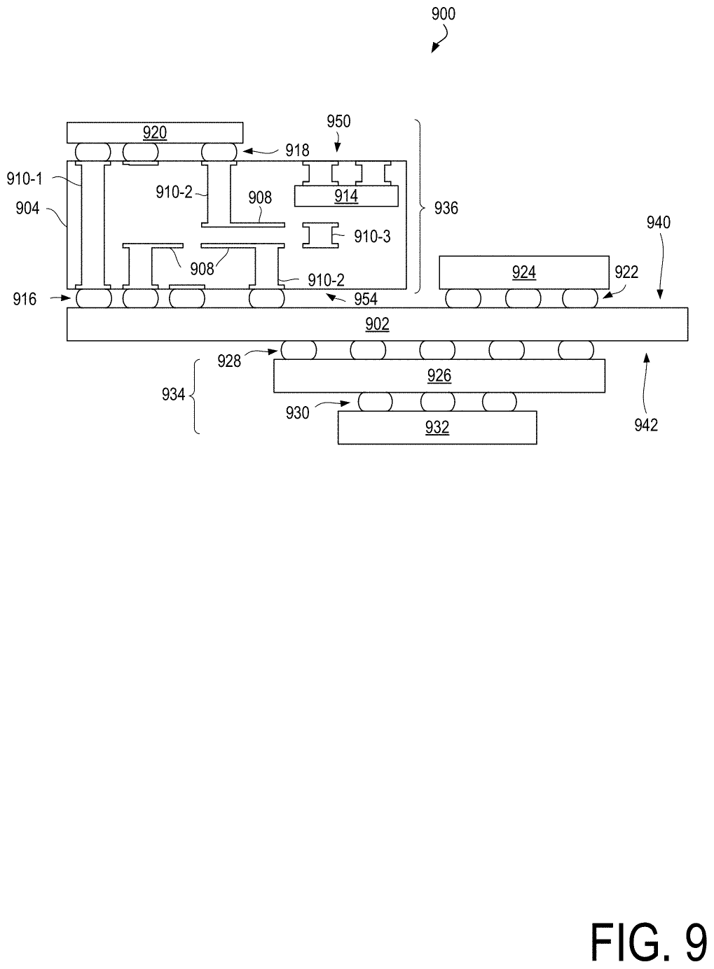

FIG. 9 is a cross-sectional side view of an integrated circuit device assembly 900 that may include any suitable circuitry disclosed herein. The integrated circuit device assembly 900 includes a number of components disposed on a circuit board 902 (which may be a motherboard, system board, mainboard, etc.). The integrated circuit device assembly 900 includes components disposed on a first face 940 of the circuit board 902 and an opposing second face 942 of the circuit board 902; generally, components may be disposed on one or both faces 940 and 942.

In some embodiments, the circuit board 902 may be a printed circuit board (PCB) including multiple metal (or interconnect) layers separated from one another by layers of dielectric material and interconnected by electrically conductive vias. The individual metal layers comprise conductive traces. Any one or more of the metal layers may be formed in a desired circuit pattern to route electrical signals (optionally in conjunction with other metal layers) between the components coupled to the circuit board 902. In other embodiments, the circuit board 902 may be a non-PCB substrate. The integrated circuit device assembly 900 illustrated in FIG. 9 includes a package-on-interposer structure 936 coupled to the first face 940 of the circuit board 902 by coupling components 916. The coupling components 916 may electrically and mechanically couple the package-on-interposer structure 936 to the circuit board 902, and may include solder balls (as shown in FIG. 9), pins (e.g., as part of a pin grid array (PGA), contacts (e.g., as part of a land grid array (LGA)), male and female portions of a socket, an adhesive, an underfill material, and/or any other suitable electrical and/or mechanical coupling structure.

The package-on-interposer structure 936 may include an integrated circuit component 920 coupled to an interposer 904 by coupling components 918. The coupling components 918 may take any suitable form for the application, such as the forms discussed above with reference to the coupling components 916. Although a single integrated circuit component 920 is shown in FIG. 9, multiple integrated circuit components may be coupled to the interposer 904; indeed, additional interposers may be coupled to the interposer 904. The interposer 904 may provide an intervening substrate used to bridge the circuit board 902 and the integrated circuit component 920.

The integrated circuit component 920 may be a packaged or unpacked integrated circuit product that includes one or more integrated circuit dies (e.g., the die 602 of FIG. 6, the integrated circuit device 700 of FIG. 7) and/or one or more other suitable components. A packaged integrated circuit component comprises one or more integrated circuit dies mounted on a package substrate with the integrated circuit dies and package substrate encapsulated in a casing material, such as a metal, plastic, glass, or ceramic. In one example of an unpackaged integrated circuit component 920, a single monolithic integrated circuit die comprises solder bumps attached to contacts on the die. The solder bumps allow the die to be directly attached to the interposer 904. The integrated circuit component 920 can comprise one or more computing system components, such as one or more processor units (e.g., system-on-a-chip (SoC), processor core, graphics processor unit (GPU), accelerator, chipset processor), I/O controller, memory, or network interface controller. In some embodiments, the integrated circuit component 920 can comprise one or more additional active or passive devices such as capacitors, decoupling capacitors, resistors, inductors, fuses, diodes, transformers, sensors, electrostatic discharge (ESD) devices, and memory devices.

In embodiments where the integrated circuit component 920 comprises multiple integrated circuit dies, they dies can be of the same type (a homogeneous multi-die integrated circuit component) or of two or more different types (a heterogeneous multi-die integrated circuit component). A multi-die integrated circuit component can be referred to as a multi-chip package (MCP) or multi-chip module (MCM).

In addition to comprising one or more processor units, the integrated circuit component 920 can comprise additional components, such as embedded DRAM, stacked high bandwidth memory (HBM), shared cache memories, input/output (I/O) controllers, or memory controllers. Any of these additional components can be located on the same integrated circuit die as a processor unit, or on one or more integrated circuit dies separate from the integrated circuit dies comprising the processor units. These separate integrated circuit dies can be referred to as “chiplets”. In embodiments where an integrated circuit component comprises multiple integrated circuit dies, interconnections between dies can be provided by the package substrate, one or more silicon interposers, one or more silicon bridges embedded in the package substrate (such as Intel® embedded multi-die interconnect bridges (EMIBs)), or combinations thereof.

Generally, the interposer 904 may spread connections to a wider pitch or reroute a connection to a different connection. For example, the interposer 904 may couple the integrated circuit component 920 to a set of ball grid array (BGA) conductive contacts of the coupling components 916 for coupling to the circuit board 902. In the embodiment illustrated in FIG. 9, the integrated circuit component 920 and the circuit board 902 are attached to opposing sides of the interposer 904; in other embodiments, the integrated circuit component 920 and the circuit board 902 may be attached to a same side of the interposer 904. In some embodiments, three or more components may be interconnected by way of the interposer 904.

In some embodiments, the interposer 904 may be formed as a PCB, including multiple metal layers separated from one another by layers of dielectric material and interconnected by electrically conductive vias. In some embodiments, the interposer 904 may be formed of an epoxy resin, a fiberglass-reinforced epoxy resin, an epoxy resin with inorganic fillers, a ceramic material, or a polymer material such as polyimide. In some embodiments, the interposer 904 may be formed of alternate rigid or flexible materials that may include the same materials described above for use in a semiconductor substrate, such as silicon, germanium, and other group III-V and group IV materials. The interposer 904 may include metal interconnects 908 and vias 910, including but not limited to through hole vias 910-1 (that extend from a first face 950 of the interposer 904 to a second face 954 of the interposer 904), blind vias 910-2 (that extend from the first or second faces 950 or 954 of the interposer 904 to an internal metal layer), and buried vias 910-3 (that connect internal metal layers).

In some embodiments, the interposer 904 can comprise a silicon interposer. Through silicon vias (TSV) extending through the silicon interposer can connect connections on a first face of a silicon interposer to an opposing second face of the silicon interposer. In some embodiments, an interposer 904 comprising a silicon interposer can further comprise one or more routing layers to route connections on a first face of the interposer 904 to an opposing second face of the interposer 904.

The interposer 904 may further include embedded devices 914, including both passive and active devices. Such devices may include, but are not limited to, capacitors, decoupling capacitors, resistors, inductors, fuses, diodes, transformers, sensors, electrostatic discharge (ESD) devices, and memory devices. More complex devices such as radio frequency devices, power amplifiers, power management devices, antennas, arrays, sensors, and microelectromechanical systems (MEMS) devices may also be formed on the interposer 904. The package-on-interposer structure 936 may take the form of any of the package-on-interposer structures known in the art. In embodiments where the interposer is a non-printed circuit board

The integrated circuit device assembly 900 may include an integrated circuit component 924 coupled to the first face 940 of the circuit board 902 by coupling components 922. The coupling components 922 may take the form of any of the embodiments discussed above with reference to the coupling components 916, and the integrated circuit component 924 may take the form of any of the embodiments discussed above with reference to the integrated circuit component 920.

The integrated circuit device assembly 900 illustrated in FIG. 9 includes a package-on-package structure 934 coupled to the second face 942 of the circuit board 902 by coupling components 928. The package-on-package structure 934 may include an integrated circuit component 926 and an integrated circuit component 932 coupled together by coupling components 930 such that the integrated circuit component 926 is disposed between the circuit board 902 and the integrated circuit component 932. The coupling components 928 and 930 may take the form of any of the embodiments of the coupling components 916 discussed above, and the integrated circuit components 926 and 932 may take the form of any of the embodiments of the integrated circuit component 920 discussed above. The package-on-package structure 934 may be configured in accordance with any of the package-on-package structures known in the art.

FIG. 10 is a block diagram of an example electrical device 1000 that may include one or more of the circuitry 210, 212, 214 disclosed herein. For example, any suitable ones of the components of the electrical device 1000 may include one or more of the integrated circuit device assemblies 900, integrated circuit components 920, integrated circuit devices 700, or integrated circuit dies 602 disclosed herein. A number of components are illustrated in FIG. 10 as included in the electrical device 1000, but any one or more of these components may be omitted or duplicated, as suitable for the application. In some embodiments, some or all of the components included in the electrical device 1000 may be attached to one or more motherboards mainboards, or system boards. In some embodiments, one or more of these components are fabricated onto a single system-on-a-chip (SoC) die.

Additionally, in various embodiments, the electrical device 1000 may not include one or more of the components illustrated in FIG. 10, but the electrical device 1000 may include interface circuitry for coupling to the one or more components. For example, the electrical device 1000 may not include a display device 1006, but may include display device interface circuitry (e.g., a connector and driver circuitry) to which a display device 1006 may be coupled. In another set of examples, the electrical device 1000 may not include an audio input device 1024 or an audio output device 1008, but may include audio input or output device interface circuitry (e.g., connectors and supporting circuitry) to which an audio input device 1024 or audio output device 1008 may be coupled.

The electrical device 1000 may include one or more processor units 1002 (e.g., one or more processor units). As used herein, the terms “processor unit”, “processing unit” or “processor” may refer to any device or portion of a device that processes electronic data from registers and/or memory to transform that electronic data into other electronic data that may be stored in registers and/or memory. The processor unit 1002 may include one or more digital signal processors (DSPs), application-specific integrated circuits (ASICs), central processing units (CPUs), graphics processing units (GPUs), general-purpose GPUs (GPGPUs), accelerated processing units (APUs), field-programmable gate arrays (FPGAs), neural network processing units (NPUs), data processor units (DPUs), accelerators (e.g., graphics accelerator, compression accelerator, artificial intelligence accelerator), controller cryptoprocessors (specialized processors that execute cryptographic algorithms within hardware), server processors, controllers, or any other suitable type of processor units. As such, the processor unit can be referred to as an XPU (or xPU).

The electrical device 1000 may include a memory 1004, which may itself include one or more memory devices such as volatile memory (e.g., dynamic random access memory (DRAM), static random-access memory (SRAM)), non-volatile memory (e.g., read-only memory (ROM), flash memory, chalcogenide-based phase-change non-voltage memories), solid state memory, and/or a hard drive. In some embodiments, the memory 1004 may include memory that is located on the same integrated circuit die as the processor unit 1002. This memory may be used as cache memory (e.g., Level 1 (L1), Level 2 (L2), Level 3 (L3), Level 4 (L4), Last Level Cache (LLC)) and may include embedded dynamic random access memory (eDRAM) or spin transfer torque magnetic random access memory (STT-MRAM).

In some embodiments, the electrical device 1000 can comprise one or more processor units 1002 that are heterogeneous or asymmetric to another processor unit 1002 in the electrical device 1000. There can be a variety of differences between the processing units 1002 in a system in terms of a spectrum of metrics of merit including architectural, microarchitectural, thermal, power consumption characteristics, and the like. These differences can effectively manifest themselves as asymmetry and heterogeneity among the processor units 1002 in the electrical device 1000.

In some embodiments, the electrical device 1000 may include a communication component 1012 (e.g., one or more communication components). For example, the communication component 1012 can manage wireless communications for the transfer of data to and from the electrical device 1000. The term “wireless” and its derivatives may be used to describe circuits, devices, systems, methods, techniques, communications channels, etc., that may communicate data through the use of modulated electromagnetic radiation through a nonsolid medium. The term “wireless” does not imply that the associated devices do not contain any wires, although in some embodiments they might not.

The communication component 1012 may implement any of a number of wireless standards or protocols, including but not limited to Institute for Electrical and Electronic Engineers (IEEE) standards including Wi-Fi (IEEE 802.11 family), IEEE 802.16 standards (e.g., IEEE 802.16-2005 Amendment), Long-Term Evolution (LTE) project along with any amendments, updates, and/or revisions (e.g., advanced LTE project, ultra mobile broadband (UMB) project (also referred to as “3GPP2”), etc.). IEEE 802.16 compatible Broadband Wireless Access (BWA) networks are generally referred to as WiMAX networks, an acronym that stands for Worldwide Interoperability for Microwave Access, which is a certification mark for products that pass conformity and interoperability tests for the IEEE 802.16 standards. The communication component 1012 may operate in accordance with a Global System for Mobile Communication (GSM), General Packet Radio Service (GPRS), Universal Mobile Telecommunications System (UMTS), High Speed Packet Access (HSPA), Evolved HSPA (E-HSPA), or LTE network. The communication component 1012 may operate in accordance with Enhanced Data for GSM Evolution (EDGE), GSM EDGE Radio Access Network (GERAN), Universal Terrestrial Radio Access Network (UTRAN), or Evolved UTRAN (E-UTRAN). The communication component 1012 may operate in accordance with Code Division Multiple Access (CDMA), Time Division Multiple Access (TDMA), Digital Enhanced Cordless Telecommunications (DECT), Evolution-Data Optimized (EV-DO), and derivatives thereof, as well as any other wireless protocols that are designated as 3G, 4G, 5G, and beyond. The communication component 1012 may operate in accordance with other wireless protocols in other embodiments. The electrical device 1000 may include an antenna 1022 to facilitate wireless communications and/or to receive other wireless communications (such as AM or FM radio transmissions).

In some embodiments, the communication component 1012 may manage wired communications, such as electrical, optical, or any other suitable communication protocols (e.g., IEEE 802.3 Ethernet standards). As noted above, the communication component 1012 may include multiple communication components. For instance, a first communication component 1012 may be dedicated to shorter-range wireless communications such as Wi-Fi or Bluetooth, and a second communication component 1012 may be dedicated to longer-range wireless communications such as global positioning system (GPS), EDGE, GPRS, CDMA, WiMAX, LTE, EV-DO, or others. In some embodiments, a first communication component 1012 may be dedicated to wireless communications, and a second communication component 1012 may be dedicated to wired communications.

The electrical device 1000 may include battery/power circuitry 1014. The battery/power circuitry 1014 may include one or more energy storage devices (e.g., batteries or capacitors) and/or circuitry for coupling components of the electrical device 1000 to an energy source separate from the electrical device 1000 (e.g., AC line power).

The electrical device 1000 may include a display device 1006 (or corresponding interface circuitry, as discussed above). The display device 1006 may include one or more embedded or wired or wirelessly connected external visual indicators, such as a heads-up display, a computer monitor, a projector, a touchscreen display, a liquid crystal display (LCD), a light-emitting diode display, or a flat panel display.

The electrical device 1000 may include an audio output device 1008 (or corresponding interface circuitry, as discussed above). The audio output device 1008 may include any embedded or wired or wirelessly connected external device that generates an audible indicator, such speakers, headsets, or earbuds.

The electrical device 1000 may include an audio input device 1024 (or corresponding interface circuitry, as discussed above). The audio input device 1024 may include any embedded or wired or wirelessly connected device that generates a signal representative of a sound, such as microphones, microphone arrays, or digital instruments (e.g., instruments having a musical instrument digital interface (MIDI) output). The electrical device 1000 may include a Global Navigation Satellite System (GNSS) device 1018 (or corresponding interface circuitry, as discussed above), such as a Global Positioning System (GPS) device. The GNSS device 1018 may be in communication with a satellite-based system and may determine a geolocation of the electrical device 1000 based on information received from one or more GNSS satellites, as known in the art.

The electrical device 1000 may include an other output device 1010 (or corresponding interface circuitry, as discussed above). Examples of the other output device 1010 may include an audio codec, a video codec, a printer, a wired or wireless transmitter for providing information to other devices, or an additional storage device.

The electrical device 1000 may include an other input device 1020 (or corresponding interface circuitry, as discussed above). Examples of the other input device 1020 may include an accelerometer, a gyroscope, a compass, an image capture device (e.g., monoscopic or stereoscopic camera), a trackball, a trackpad, a touchpad, a keyboard, a cursor control device such as a mouse, a stylus, a touchscreen, proximity sensor, microphone, a bar code reader, a Quick Response (QR) code reader, electrocardiogram (ECG) sensor, PPG (photoplethysmogram) sensor, galvanic skin response sensor, any other sensor, or a radio frequency identification (RFID) reader.

The electrical device 1000 may have any desired form factor, such as a hand-held or mobile electrical device (e.g., a cell phone, a smart phone, a mobile internet device, a music player, a tablet computer, a laptop computer, a 2-in-1 convertible computer, a portable all-in-one computer, a netbook computer, an ultrabook computer, a personal digital assistant (PDA), an ultra mobile personal computer, a portable gaming console, etc.), a desktop electrical device, a server, a rack-level computing solution (e.g., blade, tray or sled computing systems), a workstation or other networked computing component, a printer, a scanner, a monitor, a set-top box, an entertainment control unit, a stationary gaming console, smart television, a vehicle control unit, a digital camera, a digital video recorder, a wearable electrical device or an embedded computing system (e.g., computing systems that are part of a vehicle, smart home appliance, consumer electronics product or equipment, manufacturing equipment). In some embodiments, the electrical device 1000 may be any other electronic device that processes data. In some embodiments, the electrical device 1000 may comprise multiple discrete physical components. Given the range of devices that the electrical device 1000 can be manifested as in various embodiments, in some embodiments, the electrical device 1000 can be referred to as a computing device or a computing system.

Some examples of embodiments are provided below. As used in the following examples, the term “connected” may refer to an electrical connection. In some instances, the connection may be a direct connection between two items/components. Further, as used in the following examples, the term “coupled” may refer to a connection that may be direct or indirect. For example, a first component coupled to a second component may include a third component connected between the first and second components.

Example 1 includes a system comprising first circuitry to operate in a first clock domain; second circuitry to operate in a second clock domain; and clock domain crossing circuitry, the clock domain crossing circuitry comprising a first asynchronous first-in-first-out (FIFO) queue to transfer data from the first circuitry in the first clock domain to an interconnect in a third clock domain associated with the clock domain crossing circuitry; and a second asynchronous FIFO queue to transfer data from the interconnect in the third clock domain to the second circuitry in the second clock domain.

Example 2 includes the subject matter of Example 1, and wherein the first circuitry comprises digital circuitry, and wherein the second circuitry comprises analog circuitry.

Example 3 includes the subject matter of any of Examples 1 and 2, and wherein the analog circuitry is connected to a quantum processor to interface with qubits of the quantum processor.

Example 4 includes the subject matter of any of Examples 1-3, and wherein the first circuitry, the second circuitry, and the clock domain crossing circuitry are at a temperature less than 50 Kelvin.

Example 5 includes the subject matter of any of Examples 1-4, and wherein the first circuitry comprises analog circuitry, and wherein the second circuitry comprises digital circuitry.

Example 6 includes the subject matter of any of Examples 1-5, and wherein the interconnect comprises one or more registers between the first asynchronous FIFO queue and the second asynchronous FIFO queue.

Example 7 includes the subject matter of any of Examples 1-6, and wherein the second circuitry is to transition from a lower-power state to a higher-power state in response to receipt of data at the second asynchronous FIFO queue.

Example 8 includes the subject matter of any of Examples 1-7, and wherein the first circuitry and the second circuitry are on the same die.

Example 9 includes the subject matter of any of Examples 1-8, and wherein the first circuitry and the second circuitry are separated by at least 100 micrometers.

Example 10 includes the subject matter of any of Examples 1-9, and wherein the first circuitry and the second circuitry are in the same package on different dies.

Example 11 includes the subject matter of any of Examples 1-10, and wherein the first circuitry and the second circuitry are in different packages.

Example 12 includes the subject matter of any of Examples 1-11, and wherein a first clock corresponding to the first clock domain is asynchronous to a second clock corresponding to the second clock domain.

Example 13 includes the subject matter of any of Examples 1-12, and wherein a first clock corresponding to the first clock domain is synchronous to a second clock corresponding to the second clock domain, wherein a frequency of the first clock is different from a frequency of the second clock.

Example 14 includes the subject matter of any of Examples 1-13, and wherein a first clock corresponding to the first clock domain has the same frequency and phase as a second clock corresponding to the second clock domain.

Example 15 includes the subject matter of any of Examples 1-14, and further including a processor communicatively coupled to the first circuitry; a memory communicatively coupled to the processor; and a quantum processor communicatively coupled to the second circuitry.

Example 16 includes a system comprising a die comprising first circuitry to operate in a first clock domain, wherein a first clock corresponding to the first clock domain is to operate at a nominal frequency; second circuitry to operate in a second clock domain, wherein a second clock corresponding to the second clock domain is asynchronous to the first clock; and clock domain crossing circuitry, the clock domain crossing circuitry to asynchronously transfer data from the first circuitry to the second circuitry, wherein the clock domain crossing circuitry is able to asynchronously transfer data from the first circuitry to the second circuitry when the first clock is operated at each of the nominal frequency, three-quarters of the nominal frequency, and half the nominal frequency.

Example 17 includes the subject matter of Example 16, and wherein the clock domain crossing circuitry comprises a first asynchronous first-in-first-out (FIFO) queue to transfer data from the first circuitry in the first clock domain to an interconnect in a third clock domain associated with the clock domain crossing circuitry; and a second asynchronous FIFO queue to transfer data from the interconnect in the third clock domain to the second circuitry in the second clock domain.

Example 18 includes the subject matter of any of Examples 16 and 17, and wherein the interconnect comprises one or more registers between the first asynchronous FIFO queue and the second asynchronous FIFO queue.

Example 19 includes the subject matter of any of Examples 16-18, and wherein the second circuitry is to transition from a lower-power state to a higher-power state in response to receipt of data at the second asynchronous FIFO queue.

Example 20 includes the subject matter of any of Examples 16-19, and wherein the first circuitry comprises digital circuitry, and wherein the second circuitry comprises analog circuitry.

Example 21 includes the subject matter of any of Examples 16-20, and wherein the analog circuitry is connected to a quantum processor to interface with qubits of the quantum processor.

Example 22 includes the subject matter of any of Examples 16-21, and wherein the first circuitry, the second circuitry, and the clock domain crossing circuitry are at a temperature less than 50 Kelvin.

Example 23 includes the subject matter of any of Examples 16-22, and wherein the first circuitry comprises analog circuitry, and wherein the second circuitry comprises digital circuitry.

Example 24 includes the subject matter of any of Examples 16-23, and wherein the first circuitry and the second circuitry are separated by at least 100 micrometers.

Example 25 includes the subject matter of any of Examples 16-24, and wherein a first clock corresponding to the first clock domain is synchronous to a second clock corresponding to the second clock domain, wherein a frequency of the first clock is different from a frequency of the second clock.

Example 26 includes the subject matter of any of Examples 16-25, and wherein a first clock corresponding to the first clock domain has the same frequency and phase as a second clock corresponding to the second clock domain.

Example 27 includes the subject matter of any of Examples 16-26, and further including a processor communicatively coupled to the first circuitry; a memory communicatively coupled to the processor; and a quantum processor communicatively coupled to the second circuitry.

Example 28 includes a method comprising laying out digital circuitry on a die; automatically tuning the digital circuitry to satisfy clock timing constraints; laying out analog circuitry on the die; manually tuning the analog circuitry to satisfy clock timing constraints; and laying out clock domain crossing circuitry on the die, wherein the clock domain crossing circuitry is to asynchronously transfer data from the analog circuitry to the digital circuitry.

Example 29 includes the subject matter of Example 28, and wherein laying out the clock domain crossing circuitry comprises selecting a clock domain crossing circuitry package to apply to the die; selecting one or more parameters for the clock domain crossing circuitry, wherein at least one parameter of the one or more parameters is based on a clock configuration of the digital circuitry and the analog circuitry.

Example 30 includes the subject matter of any of Examples 28 and 29, and wherein the at least one parameter indicates whether a first clock corresponding to the digital circuitry is synchronous or asynchronous to a second clock corresponding to the analog circuitry.

Example 31 includes the subject matter of any of Examples 28-30, and wherein the clock domain crossing circuitry comprises an asynchronous first-in-first-out (FIFO) queue, wherein the at least one parameter determines a number of flip flops in a synchronization stage of the asynchronous FIFO queue.

1. A system comprising:
first circuitry to operate in a first clock domain;
second circuitry to operate in a second clock domain; and
clock domain crossing circuitry, the clock domain crossing circuitry comprising:
a first asynchronous first-in-first-out (FIFO) queue to transfer data from the first circuitry in the first clock domain to an interconnect in a third clock domain associated with the clock domain crossing circuitry; and
a second asynchronous FIFO queue to transfer data from the interconnect in the third clock domain to the second circuitry in the second clock domain.

2. The system of claim 1, wherein the first circuitry comprises digital circuitry, and wherein the second circuitry comprises analog circuitry.

3. The system of claim 2, wherein the analog circuitry is connected to a quantum processor to interface with qubits of the quantum processor.

4. The system of claim 3, wherein the first circuitry, the second circuitry, and the clock domain crossing circuitry are at a temperature less than 50 Kelvin.

5. The system of claim 1, wherein the first circuitry comprises analog circuitry, and wherein the second circuitry comprises digital circuitry.

6. The system of claim 1, wherein the first circuitry and the second circuitry are on the same die.

7. The system of claim 1, wherein the first circuitry and the second circuitry are in the same package on different dies.

8. The system of claim 1, wherein the first circuitry and the second circuitry are in different packages.

9. The system of claim 1, wherein a first clock corresponding to the first clock domain is asynchronous to a second clock corresponding to the second clock domain.

10. The system of claim 1, wherein a first clock corresponding to the first clock domain is synchronous to a second clock corresponding to the second clock domain, wherein a frequency of the first clock is different from a frequency of the second clock.

11. The system of claim 1, wherein a first clock corresponding to the first clock domain has the same frequency and phase as a second clock corresponding to the second clock domain.

12. The system of claim 1, further comprising:
a processor communicatively coupled to the first circuitry;
a memory communicatively coupled to the processor; and
a quantum processor communicatively coupled to the second circuitry.

13. A system comprising:
a die comprising:
first circuitry to operate in a first clock domain, wherein a first clock corresponding to the first clock domain is to operate at a nominal frequency;
second circuitry to operate in a second clock domain, wherein a second clock corresponding to the second clock domain is asynchronous to the first clock; and
clock domain crossing circuitry, the clock domain crossing circuitry to asynchronously transfer data from the first circuitry to the second circuitry,
wherein the clock domain crossing circuitry is able to asynchronously transfer data from the first circuitry to the second circuitry when the first clock is operated at each of the nominal frequency, three-quarters of the nominal frequency, and half the nominal frequency.

14. The system of claim 13, wherein the clock domain crossing circuitry comprises:
a first asynchronous first-in-first-out (FIFO) queue to transfer data from the first circuitry in the first clock domain to an interconnect in a third clock domain associated with the clock domain crossing circuitry; and
a second asynchronous FIFO queue to transfer data from the interconnect in the third clock domain to the second circuitry in the second clock domain.

15. The system of claim 14, wherein the interconnect comprises one or more registers between the first asynchronous FIFO queue and the second asynchronous FIFO queue.

16. The system of claim 14, wherein the second circuitry is to transition from a lower-power state to a higher-power state in response to receipt of data at the second asynchronous FIFO queue.

17. The system of claim 13, wherein the first circuitry comprises digital circuitry, and wherein the second circuitry comprises analog circuitry.

18. The system of claim 17, wherein the analog circuitry is connected to a quantum processor to interface with qubits of the quantum processor.

19. The system of claim 13, wherein the first circuitry and the second circuitry are separated by at least 100 micrometers.

20. The system of claim 13, wherein a first clock corresponding to the first clock domain has the same frequency and phase as a second clock corresponding to the second clock domain.

21. The system of claim 13, further comprising:
a processor communicatively coupled to the first circuitry;
a memory communicatively coupled to the processor; and
a quantum processor communicatively coupled to the second circuitry.

22. A method comprising:
laying out digital circuitry on a die;
automatically tuning the digital circuitry to satisfy clock timing constraints;
laying out analog circuitry on the die;
manually tuning the analog circuitry to satisfy clock timing constraints; and
laying out clock domain crossing circuitry on the die, wherein the clock domain crossing circuitry is to asynchronously transfer data from the analog circuitry to the digital circuitry.

23. The method of claim 22, wherein laying out the clock domain crossing circuitry comprises:
selecting a clock domain crossing circuitry package to apply to the die;
selecting one or more parameters for the clock domain crossing circuitry, wherein at least one parameter of the one or more parameters is based on a clock configuration of the digital circuitry and the analog circuitry.

24. The method of claim 23, wherein the at least one parameter indicates whether a first clock corresponding to the digital circuitry is synchronous or asynchronous to a second clock corresponding to the analog circuitry.

25. The method of claim 24,
wherein the clock domain crossing circuitry comprises an asynchronous first-in-first-out (FIFO) queue,
wherein the at least one parameter determines a number of flip flops in a synchronization stage of the asynchronous FIFO queue.
